(19) United States
(12) Patent Application Publication
(10) Pub. No.: US 2026/0134389 A1
(43) Pub. Date: May 14, 2026

(54) VALIDATION SYSTEM

(71) Applicant: Rehrig Pacific Company, Monterey Park, CA (US)

(72) Inventors: Daniel James Thyer, Charlotte, NC (US); Dane Gin Mun Kalinowski, Foothill Ranch, CA (US); Robert Lee Martin, JR., Lucas, TX (US); Peter Douglas Jackson, Alpharetta, GA (US); Justin Michael Brown, Coppell, TX (US); Swapna Muthuru, Frisco, TX (US)

(21) Appl. No.: 19/232,471

(22) Filed: Jun. 9, 2025

Related U.S. Application Data
(60) Provisional application No. 63/657,485, filed on Jun. 7, 2024.
(60) Provisional application No. 63/760,681, filed on Feb. 20, 2025.

(51) Int. Cl. G06Q 10/087; G06T 7/246; G06T 7/70; G06V 10/12; G06V 10/98; G06V 30/19

(52) U.S. Cl. CPC G06Q 10/08741; G06T 7/246; G06T 7/70; G06V 10/12; G06V 10/98; G06V 30/19007

(57) ABSTRACT

A computer system receives an image of a package in the computer system, wherein the image includes at least one face of the package. The computer system may determine a normal vector of each of the at least one face of the package in the image. The computer system determines a SKU associated with the package based upon the normal vector and the image. The computer system compares the determined SKU with at least one of a plurality of desired SKUs. In other embodiments various embodiments of validation systems are described. An autonomous mobile robot that can be used with a validation system is also described.

### BACKGROUND

The assignee of the present invention has previously developed a validation system that, among other things, images one or more items to identify a SKU (Stock-Keeping Unit) associated with each item and compares the identified SKU(s) to a pick list. The validation system may indicate errors to a user.

In one implementation of the validation system, the items are packages stacked on a platform, such as a pallet. Images of each side of the stack of items are captured at a validation station. The system identifies a SKU associated with each package face in each image. The system ensures that each package is counted only once, even when more than one package face is imaged. The identified SKUs are then compared to a pick list to confirm that the SKUs match the pick list, or to identify any possible errors. The pick list is based upon an order and indicates a quantity of each SKU that should be placed on a pallet.

In another implementation, workers are instructed to pick items associated with SKUs based upon pick lists. The workers place the items on a conveyor. The items on the conveyor pass through a validation station one at a time. At the validation station, each item is imaged, e.g. on at least two sides, and the images are analyzed to identify the associated SKU. The system confirms that the proper item was retrieved by comparing the identified SKU to the SKUs on the pick lists. The conveyors then deliver that item to an assigned pallet. This process is repeated to load the pallets with a plurality of items of different SKUs based upon pick lists.

The items may be packages, such as packages of beverage containers, such as soft drinks, beer, energy drinks, etc. The system could also be used with other types of packages or other products or other items. There are many different packages in the warehouse or distribution center (herein, the terms are used interchangeably). Each package is associated with one of a plurality of different SKUs. A “SKU” may be a single variation of a product that is available from the distribution center. For example, each SKU may be associated with a particular package type, e.g. the number of containers (e.g. 12 pack) in a particular form (e.g. can vs bottle) and of a particular size (e.g. 24 ounces) optionally with a particular secondary container (cardboard vs reusuable plastic crate, cardboard tray with plastic overwrap, etc). In other words, the package type may include both the size, quantity and type of primary packaging (can, bottle, etc, in direct contact with the beverage or other product) and any secondary packaging (crate, tray, cardboard box, etc, containing the plurality of primary packaging containers).

Each SKU may also be associated with a particular “brand,” which in this case means the manufacturer and/or the specific variation, e.g. flavor, diet, etc. The “brand” may also be considered to be the specific content of the primary package and secondary package (if any) for which there is a package type. Each of the plurality of available SKUs in the distribution center is stored in at least one computer. Each SKU may have an associated text description, an associated package type, and an associated brand. Each SKU may also have associated dimensions (L×W×H) and an associated weight.

There are a lot of permutations of package types and brands in a warehouse, i.e. a lot of different SKUs. New SKUs are added frequently. Additionally, the appearance of existing SKUs changes frequently. For example, an exterior appearance of a package of beverage containers may be changed temporarily for a particular season or for a particular promotion.

In the existing system developed by the Assignee of the present invention, the images are analyzed by the computer system using at least one machine learning model that has been trained on images of the items available in the distribution center and the known associated SKUs. In other systems proposed by the current Assignee, the at least one machine learning model is “trained” during use in the warehouse.

In one existing system of the Assignee, the computer analyzes each image using a package type machine learning model to determine the package type only. There are a plurality of brand machine learning models that are each trained on images of packages with different brands (although overlap may be preferred depending on the application). Based upon the inferred package type, the computer then selects at least one of a plurality of brand machine learning models. In other words, by first inferring the package type, the number of potential brands is narrowed, as some package types only carry a subset of the brands available in the distribution center. The computer then analyzes the image using the selected brand machine learning model to infer a brand. The inferred package type and the inferred brand indicate the SKU associated with the package.

### SUMMARY

In some aspects, the techniques described herein relate to a method for identifying a SKU of a package using a computer system having at least one processor, wherein the computer system stores a plurality of pick lists, wherein each pick list indicates a quantity of each of a plurality of desired SKUs for an order (although there may be multiple pick lists for one order). The method includes: a) receiving an image of a package in the computer system, wherein the image includes at least one face of the package; b) the computer system determining a normal vector of each of the at least one face of the package in the image; c) based upon step b) and based upon the image, the computer system determining a SKU associated with the package; and d) the computer system comparing the SKU determined in step c) with at least one of the plurality of desired SKUs.

In some aspects, the techniques described herein relate to a method wherein step c) further includes correcting distortion of the image based upon the normal vector to produce a corrected image and wherein step c) further includes determining a SKU based upon the corrected image.

In some aspects, the techniques described herein relate to a method wherein the at least one face includes two faces and wherein step c) includes determining that the two faces are two faces of the package rather than two packages.

In some aspects, the techniques described herein relate to a method wherein step c) includes the computer system inferring the SKU associated with the package using at least one machine learning model, wherein the computer system includes at least one non-transitory computer-readable media storing the at least one machine learning model, wherein the at least one machine learning model is trained with a plurality of images of packages of beverage containers.

In some aspects, the techniques described herein relate to a method further including illuminating the package with at least one light while capturing the image of the package in step a), wherein based upon step d) the computer system generates a confirmation by changing the at least one light to green or an error notification by changing the at least one light to red.

In some aspects, the techniques described herein relate to a method for preventing an object from tipping on a conveyor including: a) receiving at least one image of an object in a computer system, wherein the at least one image includes at least one face of the object; and b) based upon the at least one image, the computer system determining an angle of the object relative to the conveyor or a change of the angle of the object relative to the conveyor; and c) based upon step b) the computer system stopping the conveyor.

In some aspects, the techniques described herein relate to a method wherein the object is a pallet loaded with packages.

In some aspects, the techniques described herein relate to a method wherein step b) includes the computer system determining a normal vector of at least one face of the pallet or of at least one face of at least one of the packages.

In some aspects, the techniques described herein relate to a method wherein step b) includes the computer system determining an angle of the normal vector relative to a direction of travel of the conveyor and wherein step c) is performed by the computer system based upon the angle.

In some aspects, the techniques described herein relate to a method wherein the at least one image includes at least two images, wherein step b) includes determining the normal vector in each of the at least two images, and wherein step b) includes the computer system determining a rate of rotation based upon the normal vectors determined in each of the at least two images and comparing the rate of rotation to a threshold.

In some aspects, the techniques described herein relate to a method wherein the at least one image includes at least two images, wherein step b) includes determining a normal vector of at least one face of the object in each of the at least two images, and wherein step b) includes the computer system determining a rotation of the object based upon the normal vectors determined in each of the at least two images and comparing the rotation to a threshold.

In some aspects, the techniques described herein relate to a method wherein the at least one image includes at least two images, wherein step b) includes determining a normal vector of the at least one face of the object in each of the at least two images, and wherein step b) includes the computer system determining a rate of rotation of the objected based upon the normal vectors determined in each of the at least two images and comparing the rate of rotation to a threshold.

In some aspects, the techniques described herein relate to a conveyor system including: a first conveyor leading to a second conveyor at a transition area; at least one camera directed toward the transition area; a computer system receiving at least one image from the at least one camera, the computer system configured to: a) receive the at least one image of an object proximate the transition area, wherein the at least one image includes at least one face of the object; b) based upon the at least one image, determine an angle of the object relative to the conveyor or a change of the angle of the object relative to the conveyor; and c) based upon step b) the computer system stopping at least one of the first conveyor or the second conveyor.

In some aspects, the techniques described herein relate to a conveyor system wherein the object is a pallet loaded with packages.

In some aspects, the techniques described herein relate to a conveyor system wherein step b) includes the computer system determining a normal vector of at least one face of the pallet or of at least one face of at least one of the packages.

In some aspects, the techniques described herein relate to a conveyor system wherein step b) includes the computer system determining an angle of the normal vector relative to a direction of travel of the first conveyor and wherein step c) is performed by the computer system based upon the angle.

In some aspects, the techniques described herein relate to a conveyor system wherein the at least one image includes at least two images, wherein step b) includes determining a normal vector of at least one face of the object in each of the at least two images, and wherein step c) includes the computer system determining a rotation of the object based upon the normal vectors determined in each of the at least two images and comparing the rotation to a threshold.

In some aspects, the techniques described herein relate to a conveyor system wherein the at least one image includes at least two images, wherein step b) includes determining a normal vector of at least one face of the object in each of the at least two images, and wherein step c) includes the computer system determining a rotation of the object based upon the normal vectors determined in each of the at least two images and comparing the rotation to a threshold.

In some aspects, the techniques described herein relate to a validation system including: a first camera tower having a plurality of first cameras vertically spaced from one another; and a second camera tower having a plurality of second cameras vertically spaced from one another and directed toward the plurality of first cameras, a main imaging area defined between the first camera tower and the second camera tower, the second camera tower further including a front camera directed at an oblique angle relative to the plurality of second cameras, the front camera directed toward an initial imaging area spaced away from the main imaging area.

In some aspects, the techniques described herein relate to a validation system wherein the first camera tower is between approximately 76 inches and approximately 96 inches away from the second camera tower.

In some aspects, the techniques described herein relate to a validation system wherein the first camera tower is between approximately 83 inches and approximately 96 inches away from the second camera tower.

In some aspects, the techniques described herein relate to a validation system further including a half pallet having a length longer than a width wherein a distance between the first camera tower and the second camera tower exceeds the length by approximately 24 inches or less.

In some aspects, the techniques described herein relate to a validation system further including a rear tower having a rear camera, the rear tower spaced away from the first camera tower and the second camera tower, the rear camera directed toward the main imaging area.

In some aspects, the techniques described herein relate to a validation system wherein the rear tower is positioned adjacent the initial imaging area and the rear camera is configured to image a long side of a half pallet positioned between the first camera tower and the second camera tower.

In some aspects, the techniques described herein relate to a validation system wherein the rear tower further includes a user interface for receiving an indication of a pick list or pallet id corresponding to a pallet to be validated by the validation system.

In some aspects, the techniques described herein relate to a validation system further including a computer system including: at least one processor; and at least one non-transitory computer-readable media storing: at least one machine learning model that has been trained with a plurality of images of packages; and instructions that, when executed by the at least one processor, cause the computer system to perform the following operations: a) receiving at least one image of a plurality of packages stacked on one another from each of the first cameras, the second cameras, the front camera, and the rear camera; b) identifying a SKU associated with each of the plurality of packages based upon the images received in operation a) using the at least one machine learning model; c) comparing the SKUs identified in step b) to a plurality of desired SKUs on a pick list; and d) indicating an error or a confirmation based upon step c).

In some aspects, the techniques described herein relate to a validation system further including at least one light for illuminating the plurality of packages while capturing the at least one image), wherein operation d) includes the computer system changes the at least one light to green to indicate the confirmation or the computer system changes the at least one light to red to indicate the error.

In some aspects, the techniques described herein relate to an automated mobile robot (AMR) including: a base portion; a plurality of wheels supporting the base portion; an upper platform for supporting a pallet thereon; at least one weight sensor measuring a weight on the upper platform; and at least one processor configured to receive a signal indicating the weight measured on the upper platform and to transmit the weight wirelessly via a wireless communication circuit.

In some aspects, the techniques described herein relate to an automated mobile robot further including an RFID reader configured to read a pallet id from an RFID tag of a pallet supported on the upper platform, the at least one processor configured to receive the pallet id from the RFID reader.

In some aspects, the techniques described herein relate to an automated mobile robot wherein the at least one processor is configured to cause the AMR to: retrieve at least one pallet from a pallet dispenser, receive a plurality of packages on the pallet, bring the plurality of packages to a validation station, and respond to a confirmation or error indication from the validation station.

In some aspects, the techniques described herein relate to an automated mobile robot wherein the at least one processor is configured to cause the AMR to continue to receive additional packages on the pallet based upon a confirmation from the validation station.

In some aspects, the techniques described herein relate to an automated mobile robot wherein the at least one processor is configured to cause the AMR to place the pallet and the plurality of packages on a specific spot on a floor near a loading docket based upon a command received from a remote computer.

In some aspects, the techniques described herein relate to an automated mobile robot further including at least one camera monitoring a position of the AMR and a position of the pallet and the plurality of packages and sending the position of the AMR and the position of the pallet and the plurality of packages to the remote computer.

In some aspects, the techniques described herein relate to an automated mobile robot wherein the at least one processor is configured to cause the AMR to: receive at least one package thereon, measure the weight of the at least one package using the at least one weight sensor, compare the measured weight to an expected weight of the at least one package, and bring the at least one package to a quality check station based upon a sufficient mismatch between the measured weight and the expected weight.

In some aspects, the techniques described herein relate to a validation system including the automated mobile robot, the system further including: at least one camera; wherein the at least one processor on the AMR is configured to bring a pallet and at least one object supported thereon to the at least one camera and to present sequentially each of a plurality of sides of the at least one object to the at least one camera.

In some aspects, the techniques described herein relate to a validation system wherein the at least one processor of the AMR is configured to present each of the plurality of sides of the at least one object at at least two different angles.

In some aspects, the techniques described herein relate to a method for identifying a SKU of a package using a computer system having at least one processor, wherein the computer system stores a plurality of pick lists, wherein each pick list indicates a quantity of each of a plurality of desired SKUs for an order, the method including: a) receiving in the computer system a plurality of images of a plurality of packages stacked on one another; b) the computer system identifying a bottom edge of bottom packages of the plurality of packages in each of the plurality of images; c) the computer system determining a slope of the bottom edge in each of the plurality of images; d) based upon step c) and based upon at least one of the plurality of images, the computer system determining a SKU associated with each of the plurality of packages; and e) the computer system comparing the SKUs determined in step d) with at least one of the plurality of desired SKUs.

In some aspects, the techniques described herein relate to a method wherein step d) further includes the computer system choosing the at least one of the plurality of images based upon the slopes of the bottom edges in the plurality of images and wherein the computer system determining the SKU associated with each of the plurality of packages using the at least one of the plurality of images chosen.

### BRIEF DESCRIPTION OF THE DRAWINGS

FIG. 1 shows a first embodiment of a validation station.

FIG. 2 shows material handling equipment approaching the validation station of FIG. 1 with a loaded pallet.

FIG. 3 shows the loaded pallet placed in the validation station.

FIG. 4 shows the material handling equipment driving through the validation station with the loaded pallet after validation.

FIG. 5 is a plan view of a portion of a warehouse with a validation station placed at the end of an aisle between sets of shelves containing items associated with various SKUs.

FIG. 6 shows the validation station installed over a high-speed wrapping system.

FIG. 7 is a side view of a validation station according to a second embodiment.

FIG. 8 is a top view of the validation station of FIG. 7.

FIG. 9 is a plan view showing the validation station of FIG. 7 installed proximate each of a plurality of end conveyors.

FIG. 10 shows a plurality of validation stations according to a third embodiment.

FIG. 11 is a perspective view of an autonomous mobile robot or AMR with its retractable lifts shown in a retracted position.

FIG. 12 shows the AMR of FIG. 11 with the retractable lifts shown in the deployed position.

FIG. 13 is a schematic, simplified side view of the AMR of FIG. 11.

FIG. 14 shows the AMR of FIG. 11 retrieving a pallet from a pallet dispenser.

FIG. 15 shows a pallet supported on the base portion of the AMR of FIG. 11.

FIG. 16 shows the AMR of FIG. 15 bringing the pallet to a layer pick line.

FIG. 17 shows the AMR retrieving the loaded pallet.

FIG. 18 shows the AMR bringing the loaded pallet through a validation station.

FIG. 19 shows a plurality of AMRs in a manual pick lane in the warehouse.

FIG. 20 shows a worker placing item(s) on the pallet on the AMR.

FIG. 21 shows the AMR used with a pallet to carry larger items, such as kegs.

FIG. 22 shows the AMR, pallet and kegs of FIG. 21 with additional items supported on a slip sheet thereon.

FIG. 23 shows the AMRs bringing the loaded pallets to a wrapper.

FIG. 24 illustrates a plurality of AMRs, each bringing a different type of pallet (keg pallet, full-size pallet, half pallet) through a validation station and then to a wrapper (if the load is validated).

FIG. 25 shows a plurality of parallel wrappers with turntables.

FIG. 26 shows a plurality of parallel wrappers having rotatable arms.

FIG. 27 shows multiple AMRs bringing loaded pallets to a loading dock.

FIG. 28 shows the AMRS of FIG. 27 loading pallets onto trucks.

FIG. 29 shows a validation station including a camera tower having a plurality of cameras.

FIG. 30 shows sample images from the plurality of cameras of FIG. 29.

FIG. 31 shows the composite of the images stitched together from FIG. 30.

FIG. 32 shows the bounding boxes for each of the items in the composite image of FIG. 31 as determined by the computer.

FIG. 33 shows a plan view of a more specific example of a validation station using a plurality of the camera towers of FIG. 29.

FIG. 34 shows a side view of another example of a validation system for use with the AMR using only a single camera tower of FIG. 29.

FIG. 35 shows a plan view of a validation station having the camera tower of FIG. 29 positioned very near a main imaging area.

FIG. 36 is a first perspective view of the validation station of FIG. 35.

FIG. 37 is a second perspective view of the validation station of FIG. 35.

FIG. 38 is third perspective view of the validation station of FIG. 35.

FIGS. 39 and 40 demonstrate how the computer analyzes images of the loaded pallet to determine a “slope” formed by the bottom edges of the bottom items in the stack.

FIG. 41 shows a high speed wrapper conveyor system.

FIG. 42 shows the high speed wrapper conveyor system of FIG. 42, with one of the loaded pallets starting to rotate about a vertical axis prior to tipping.

FIG. 43 is a schematic plan view of a portion of the high speed wrapper conveyor system of FIG. 41.

FIG. 44 is a schematic plan view of a portion of the high speed wrapper conveyor system of FIG. 41.

FIG. 45 is a schematic plan view of a portion of the high speed wrapper conveyor system of FIG. 41, with optional equipment proximate the weigh conveyor.

### DETAILED DESCRIPTION OF PREFERRED EMBODIMENTS

The present disclosure presents several novel configurations of the validation station in several implementations. The present disclosure also presents several novel implementations of the validation station together with an autonomous mobile robot (AMR) in a validation system as well as an improved AMR for use with a validation station. Unless otherwise explicitly stated, any feature in one embodiment could be used in any other embodiment disclosed herein.

### Validation Station

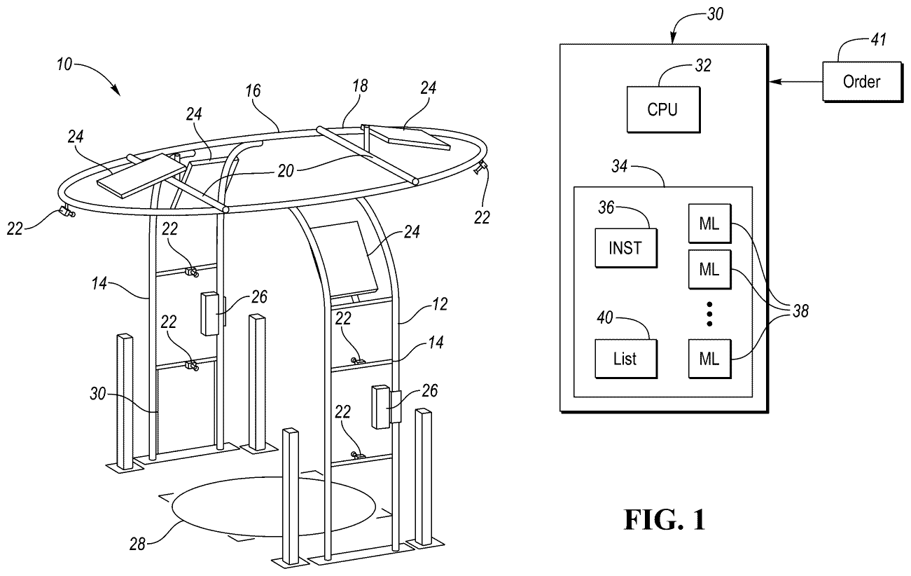

FIG. 1 shows a first embodiment of a validation station 10. The validation station 10 includes a frame 12 having vertical supports 14 that are spaced apart and substantially vertical before curving inward at the tops, as shown. The vertical supports 14 are supported on (and/or secured to) a floor and support side edges of an upper structure 16 at upper ends thereof. The upper structure 16 includes a ring 18, which may be round or oval. A pair of cross-beams 20 extend across an interior of the ring 18.

A plurality of cameras 22 may be secured to the frame 12. In this example, there are two cameras 22 secured to each of the vertical supports 14 and directed inward. The cameras 22 may be directed inward at different angles so that it is unlikely that both would experience significant glare. A camera 22 is mounted at a front end of the ring 18 and directed downward and rearward. Another camera 22 is mounted at a rear end of the ring 18 and is directed downward and forward.

A plurality of lights 24 may be mounted to the frame 12. In this example, one light 24 is mounted to each vertical support 14 and one light 24 is mounted to each cross-beam 20. Each light 24 is directed downward and inward. The lights 24 may be panel lights.

One or more RFID readers 26 may also be secured to the frame 12. In this example, one RFID reader 26 is mounted to each of the vertical supports 14.

Optionally, a weight sensing platform 28 may be mounted on or in the floor within the frame 12. The weight sensing platform 28 includes a weight sensor that generates a signal indicating the weight on the upper surface of the weight sensing platform 28.

A computer 30 may be secured to or near the frame 12. As shown in the schematic of FIG. 1, the computer 30 includes at least one processor 32 and at least one computer storage 34, which may be any form of electronic, magnetic, optical or other non-transient computer readable storage medium. The at least one computer storage 34 stores instructions, which when executed by the at least one processor 32 cause the validation station 10 to perform the functions described herein. The at least one computer storage 34 also includes at least one machine learning model 38 and preferably a plurality of machine learning models 38. The at least one machine learning model 38 is trained with known images of packages and their associated SKUs. For example, each face of a sample of each product may be photographed and manually labeled to train the at least one machine learning model 38. The at least one machine learning model 38 may include a package type machine learning model and a plurality of brand machine learning models, which are used as explained previously.

The specific location where any of the computer operations described herein takes place is not limiting and some of the operations may be distributed across several different physical or virtual servers at the same or different locations. Thus unless otherwise explicitly stated otherwise, the term “the computer” or “the computer 30” may include more than one computer, more than one processor, more than one storage, all in the same or different physical locations, in any arrangement (e.g. remote server, cloud computer, local computer, networked computers, virtual computers, portable devices, tablets, smartphones, etc).

The computer 30 is programmed to receive orders 41, such as from stores. Each order 41 indicates a quantity of each of a plurality of SKUs that are available in the warehouse. The computer 30 is programmed to generate pick lists 40 based upon the orders 41. Each pick list 40 indicates a quantity of each of a plurality of SKUs that should go on a single pallet.

The computer 30 is programmed to receive an image from at least one of the cameras 22 detecting the presence of the packages. The computer 30 is configured to initiate imaging by the cameras 22 in response to the detected presence of the packages and to receive the images from the cameras 22. The computer 30 is programmed to use the at least one machine learning model 38 to infer a SKU for each item based upon the images and optionally also based upon the weight signal from the weight sensing platform 28. As explained above, the computer 30 may first use the package type machine learning model to identify a package type and then choose one or more brand machine learning models to analyze the image to identify the brand associated with the item.

The computer 30 may identify the pallet by receiving signals from the RFID reader 26. Alternatively, a user indicates the pick list to the computer 30 at the validation station 10 (e.g. by scanning a barcode). Alternatively, the computer 30 can analyze an image from one or more of the cameras 22 to read a label on the pallet that has been previously associated with the pick list. The computer 30 can then retrieve the pick list. The computer 30 then determines if the inferred SKUs match the pick list associated with that pallet.

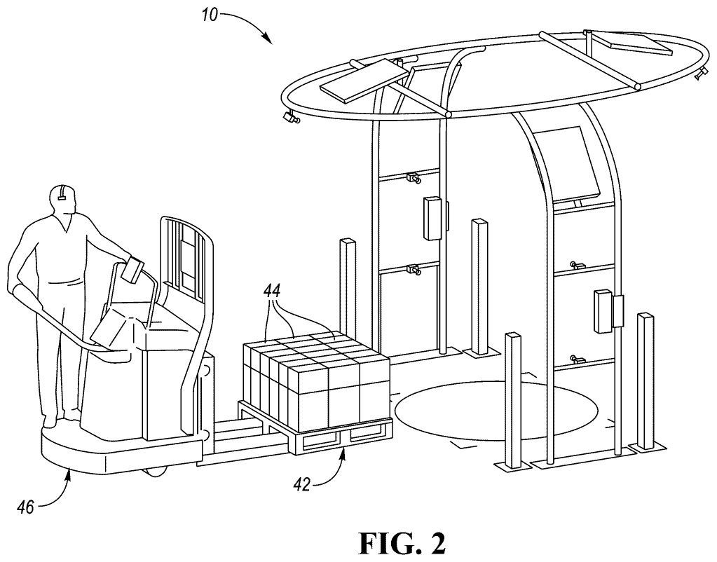

The validation station 10 can be installed for many different types of implementations. In the example shown in FIG. 2, the validation station 10 is installed in an open area of a floor. In this example, material handling equipment 46 (such as a pallet jack, pallet sled, forklift, or walkie rider (shown)) brings at least one pallet 42 loaded with items 44 to the validation station 10. In this example, the pallet 42 is a single full-size pallet, but the material handling equipment 46 can bring more than one pallet, including half pallets or full size pallets; however, only one pallet is imaged at a time in this embodiment.

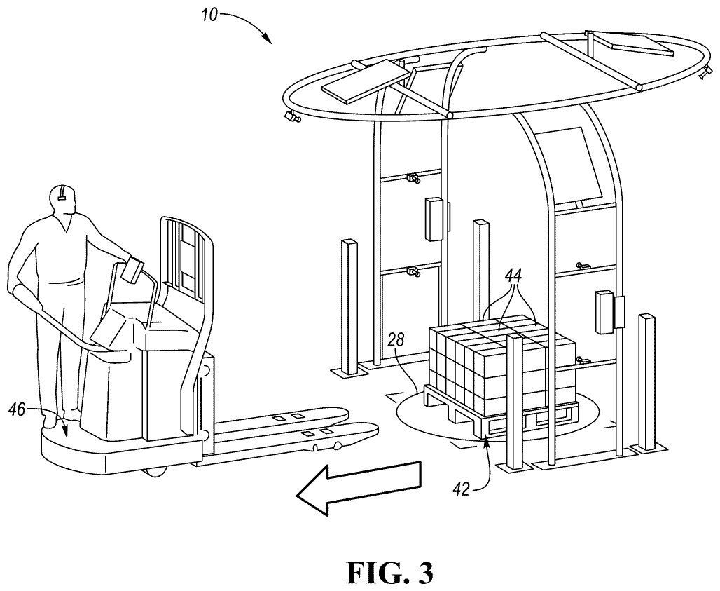

Referring to FIG. 3, the material handling equipment 46 places the loaded pallet 42 under the validation station 10 (e.g. on the weight sensing platform 28) and backs away.

Agan, the computer 30 detects the presence of the items 44 and the pallet 42 and initiates imaging. The computer 30 controls the cameras 22 (and optionally the lights 24) to take at least one image of each of the four sides of the items 44 on the pallet 42. The computer 30 may read a label on the pallet 42 to pull the pick list, or the one or more RFID readers 26 may read an RFID tag on the pallet 42, or the driver presents a barcode to the validation station 10 to pull the pick list.

The computer 30 then analyzes the images to identify the SKUs of the items 44 on the pallet 42 (e.g. by inferring package type and brand). The computer 30 then compares the identified SKUs to the pick list 40 associated with that pallet 42, optionally together with considering the weight of the items 44 and pallet 42 (compared to the expected weight of the SKUs on the pick list and the known weight of the pallet 42).

If the identified SKUs match the pick list 40, then the computer 30 so indicates to the user. If the identified SKUs do not match the pick list 40, then the computer 30 identifies the errors to the user (e.g. via a user interface on the material handling equipment 46 or a mobile device carried by the user) and/or the computer 30 sends the errors to a quality control station for correction (e.g. by associating the identified errors with that pallet 42, which can again be identified via its RFID tag).

One way that the computer 30 can indicate to the user whether the identified SKUs match the pick list 40 is using the lights 24. If the identified SKUs match the pick list 40, then the computer 30 causes the lights 24 to illuminate or flash green. If the identified SKUs do not match the pick list 40, then the computer 30 causes the lights 24 to illuminate or flash red. Alternatively, or additionally, the computer 30 may also send a signal to the a mobile device or other display on the material handling equipment 46 indicating whether to proceed to the loading dock (if matched) or to a quality control station (if not matched).

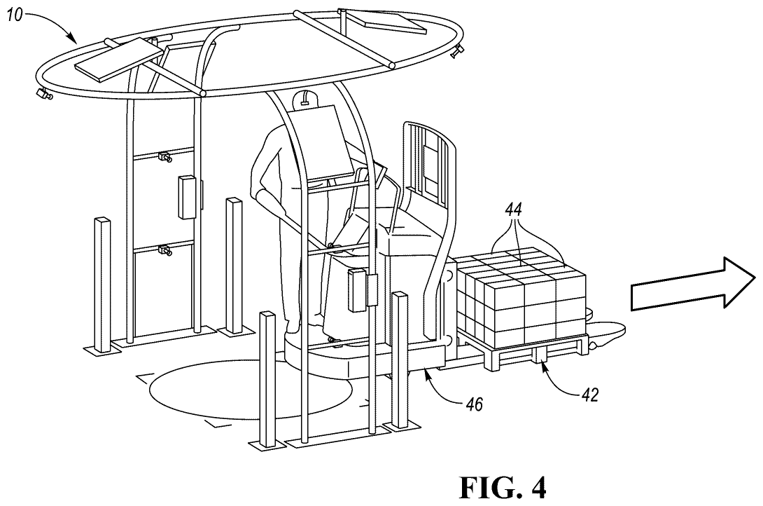

Referring to FIG. 4, the material handling equipment 46 then retrieves the pallet 42 and drives through the validation station 10 to either the quality control station or the loading dock, as instructed. Alternatively, if it was known that loading of the pallet 42 was not yet complete, the user may then take the pallet 42 to add more items 44 to the pallet 42.

### Halo Validation Station in a Warehouse

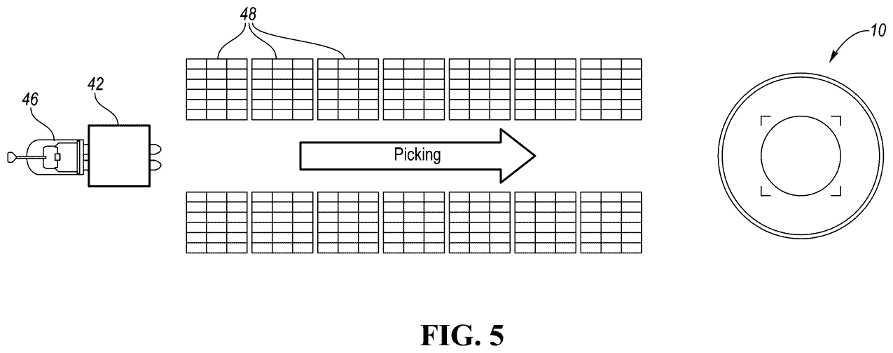

FIG. 5 is a plan view of a portion of a warehouse (e.g. an aisle). A validation station 10 can be placed at the end of an aisle between sets of shelves 48 containing items associated with various SKUs. The validation station 10 can validate the items 44 on the pallet 42 after workers pick items 44 from the shelves 48. The validation station 10 occupies very little floor space and is therefore easy to install in an existing floorplan in a warehouse. The validation station 10 could even be installed in an aisle, e.g. between sets of shelves 48.

In one implementation, a plurality of validation stations 10 are installed at ends of aisles and/or within the aisles. This would facilitate interim validations of partial loads.

The computer 30 knows what SKUs have already been instructed to be picked and therefore knows what SKUs should be on a partially-loaded pallet 42 when the validation station 10 performs an interim validation scan. The computer 30 identifies the SKUs of the items on the pallet 42 and compares those identified SKUs to the SKUs that should have been loaded from the pick list 40. The computer 30 then either indicates what corrections should be made or indicates that the items are correct so far. Performing interim validations increases the accuracy of the validation, and does so at a time when correction (e.g. replacing an item with a different item) would be easier.

### Validation Station Installed Over High-speed Wrapping System

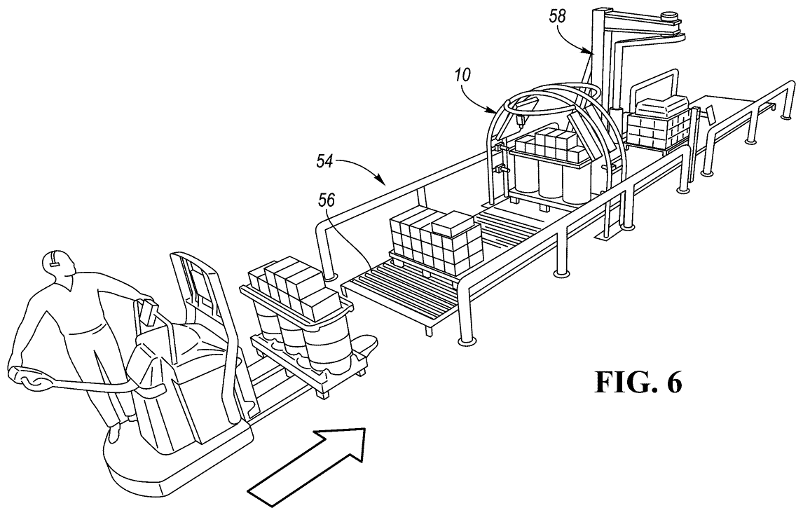

FIG. 6 shows the validation station 10 installed over a high-speed wrapping system 54 (or automated pallet wrapping system). The high-speed wrapping system 54 generally includes a conveyor 56 and a wrapper 58. The wrapper 58 is configured to wrap stretch wrap around the items 44 on the pallet 42 on the conveyor 56.

The validation station 10 is shown installed over a portion of the conveyor 56 upstream of the wrapper 58. The validation station 10 can image the items 44 on the pallet 42 as the pallet 42 passes by on the conveyor 56. The validation station 10 then identifies the SKUs of the items 44 and compares them to the pick list 40 as explained herein. Optionally, if the SKUs of the items 44 on the pallet 42 do not match the pick list 40, the computer 30 can instruct the wrapper 58 not to wrap the pallet 42 so that the pallet 42 passes by the wrapper 58 to the end of the conveyor 56. Again, the computer 30 indicates the error to the user in any of the ways described herein. The pallet 42 is then retrieved and the items 44 are corrected. The pallet 42 with the corrected items 44 can then be placed back onto the conveyor 56 to be validated again and, if appropriate, to be wrapped.

As is apparent, it is easy to retrofit an existing high speed wrapping system 54 with the validation station 10 in the manner shown. The validation station 10 occupies very little additional floorspace.

### Second Overhead Validation Station

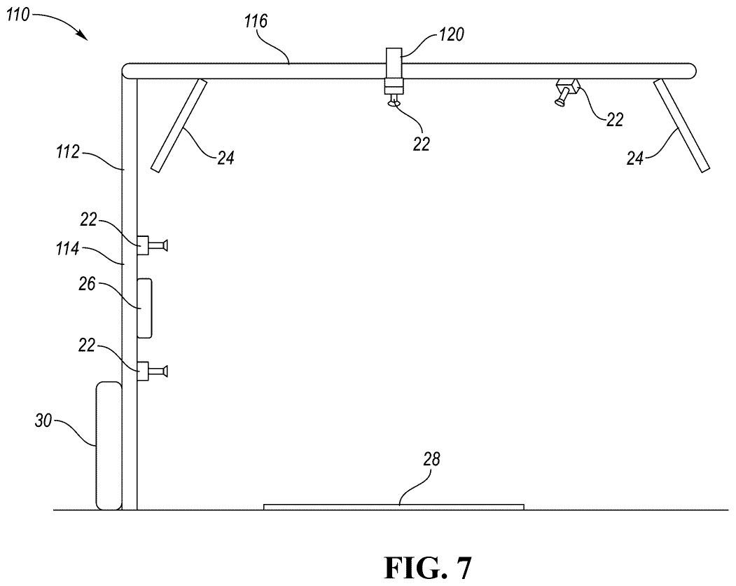

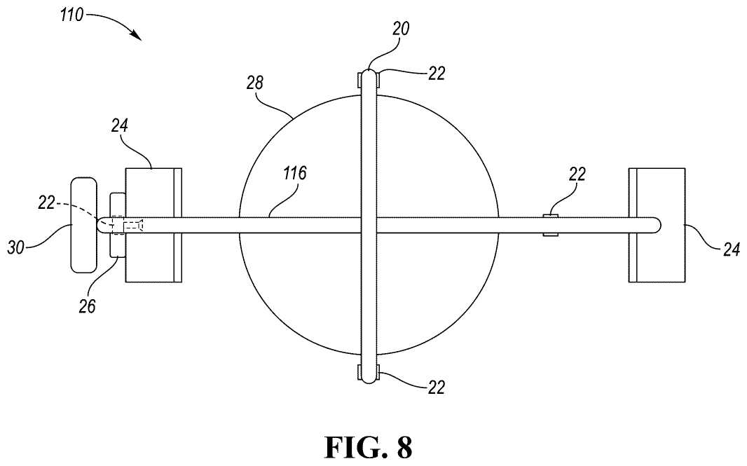

FIGS. 7 and 8 show side and top views of a validation station 110 according to a second embodiment. The validation station 110 operates in the same way as the validation station 10 of the previous embodiment, but has different structure. The validation station 110 includes a frame 112 having a vertical support 114 (only on one side). An upper structure 116 is cantilevered from an uppermost end of the vertical support 114. A cross beam 120 is supported by the upper structure 116 and projects perpendicularly forward and rearward thereof.

The frame 112 supports a plurality of cameras 22 and lights 24. There may be at least one and optionally two or more cameras 22 mounted to the vertical support 114, spaced below the upper structure 116, such that they can image one side of a stack of items on a pallet. A camera 22 is mounted proximate the cantilevered end of the cross beam 120 such that it can image an opposite side of the stack of items on a pallet. A camera 22 is mounted proximate each end of the cross beam 120 and is directed downward and inward such that they can image front and rear sides of the stack of items on a pallet. The cameras 22 are directed toward a volume above the optional weight sensing platform 28.

Lights 24 may be mounted to various locations on the frame 112, such as proximate each end of the upper structure 116. Optionally, additional lights (not shown) may be mounted proximate each end of the cross beam 120.

The RFID reader 26 may be mounted to the vertical support 114. The computer 30 again controls and receives signals from the cameras 22, RFID reader 26 and weight sensing platform 28.

The validation station 110 could optionally be used in place of the validation station 10 in FIGS. 1-6. The computer 30 receives images of each of the four sides of the stack of items on a pallet from the cameras 22. For the overhead cameras, the image will be taken at a significant angle. This will introduce a keystone effect into the image. The computer 30 may be programmed to automatically remove the keystone effect from any images from the overhead cameras 22 prior to further processing (e.g. isolating the portions of each image representing each package face, inferring package type, inferring brand, etc). Otherwise, the validation station 110 operates in the same way as the validation station 10 of FIGS. 1-10.

Optionally, all the cameras 22 may be mounted overhead (i.e. rather than having one or two mounted to the vertical support 114 and spaced below the upper structure 116).

### Overhead Validation Station at End of Conveyor System

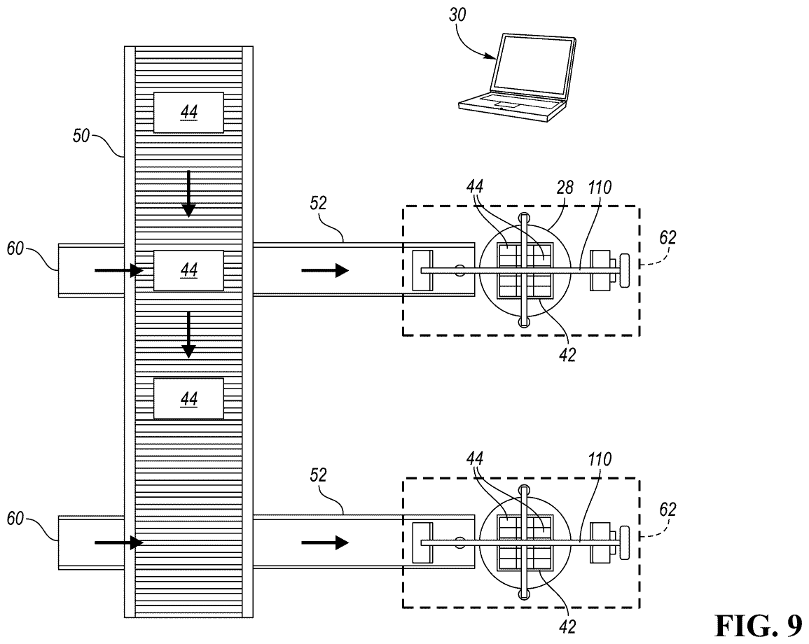

FIG. 9 shows the validation station 110 installed proximate each of a plurality of end conveyors 52. As is known, a wave conveyor 50 carries items 44 (such as packages) which are redirected by diverters 60 onto one of a plurality of end conveyors 52, each of which lead to an area proximate a loading station 62 where the items 44 are placed onto a pallet 42. The conveyor system of FIG. 9 is shown in simplified form and is generally known, but with the addition of the validation stations 110. A validation station 110 is mounted at each loading station 62. The pallet 42 being loaded is positioned below the validation station 110.

In one embodiment, the validation station 110 detects each item 44 as it is placed on the pallet 42 and takes images in response. One or more of the cameras 22 may take images at a sufficient rate that the computer 30 can analyze the images to detect the presence of each new item 44 placed on the stack. Alternatively, or additionally, the weight sensing platform 28 could detect the placement of each new item 44 to trigger activation of the cameras 22. Then all the cameras 22 are controlled by the computer 30 to take at least one image each to identify the SKU of the new item 44. The computer 30 uses the images to identify the SKU of the new item 44 (e.g. by using the at least one machine learning model 38 (FIG. 1) or by using a package type machine learning model to identify a package type and then using a brand machine learning model selected based upon the identified package type).

In one embodiment, the computer 30 compares the identified SKU of each new item to 44 the pick list as it is added to the stack. The computer 30 compares the SKU of each new item 44 as it is identified to the remaining quantities of SKUs needed to fulfill the pick list 40. As each SKU is identified on the stack, the computer 30 marks that SKU as completed from the pick list 40 until the entire pick list 40 is complete. If a new item 44 is identified as a SKU that is not on the pick list 40, or has already been loaded in sufficient quantity to fulfill the pick list 40, then the computer 30 generates an error message to the worker (e.g. as explained above, such as via red lights 24 and/or via a user's mobile device).

The computer 30 (via a visual and/or audible user interface) could indicate to the worker immediately if an incorrect item 44 is placed on the pallet 42. For example, if the new item 44 placed on the pallet 42 is identified as a SKU that is not on the pick list at all, or if an excess quantity of that SKU has been placed on the stack, the computer 30 can immediately indicate the error to the worker. For example, the computer 30 can control lights (or lasers) on the frame 112 that shine red for an error (e.g. projecting the light onto the floor) and/or generate audible alarms and/or initiate tactile feedback on a user-worn device. The computer 30 can indicate to the user specifically what the error is and how to remedy it. The computer 30 can also generate a green light as soon as the last desired SKU is identified on the pallet 42 (according to the pick list) and the pallet 42 is complete.

Alternatively, or additionally, the computer 30 tallies the number of items 44 of each SKU added to the pallet 42 and then compares the totals to the pick list when requested by the user before the pallet 42 is removed from the validation station 110.

Normally, items 44 that are placed in the interior of a full-size pallet would not be visible when the stack is complete and therefore could not be directly validated from images of the complete stack. However, by capturing images as the stack is being built (e.g. after each item 44 is added to the pallet 42) all items 44 in the stack can be validated, even if they are eventually completely hidden.

Optionally, one or more of the cameras 22 takes at least one image of the new item 44 as it is being moved toward the stack of the pallet 42. This at least one image can be analyzed as described herein to identify the SKU associated with the new item 44. The new item 44 may be more visible as it is being moved toward the stack than it is after it is placed on the stack.

### Overhead Validation Station at Loading Dock Bay Door

FIG. 10 shows a plurality of validation stations 210 according to another embodiment. Each validation station 210 includes a frame supported solely from above (e.g. from a ceiling) and having a plurality of cameras 22 mounted to the frame and directed inward and downward toward an area proximate a loading dock bay. The cameras 22 image four sides of a stack of items on a pallet as it is being carried toward the associated loading dock door. The images are analyzed by the computer 30 as discussed above and the SKUs of each item in the stack is identified. Again, the computer 30 may remove keystone distortion from the images caused by the fact that the cameras 22 are mounted overhead and directed at the items at a angle significantly different from perpendicular.

The list of identified SKUs can be used in one or more of several ways.

First, this can be used to validate that the SKUs on the pallet match the pick list as explained above. Again, confirmation or alerts and/or corrective instructions would be generated in response.

Second, the SKUs identified on the pallet could be used to identify the pallet by finding a matching pick list. In other words, especially if the pallet has already been validated, the unique combination and quantity of SKUs on the pallet uniquely identify that pallet. Then the computer 30 could verify that the pallet is being carried toward the correct loading dock door (and the correct truck) and that the pallet is being loaded onto that truck in the correct sequence. If not, the computer provides feedback to the worker (e.g. “wrong bay,” or “wrong sequence”). With this method, the pallet can be identified without the use of RFID tags and RFID readers.

Unless otherwise specified, any of the disclosed validation stations 10, 110, 210 could be used in any of the disclosed applications herein, although some may be more advantageous depending on the particular implementation.

### Autonomous Mobile Robot

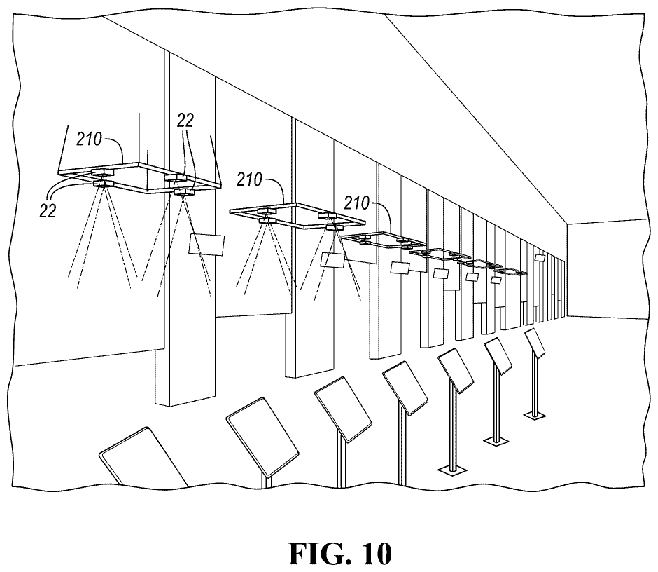

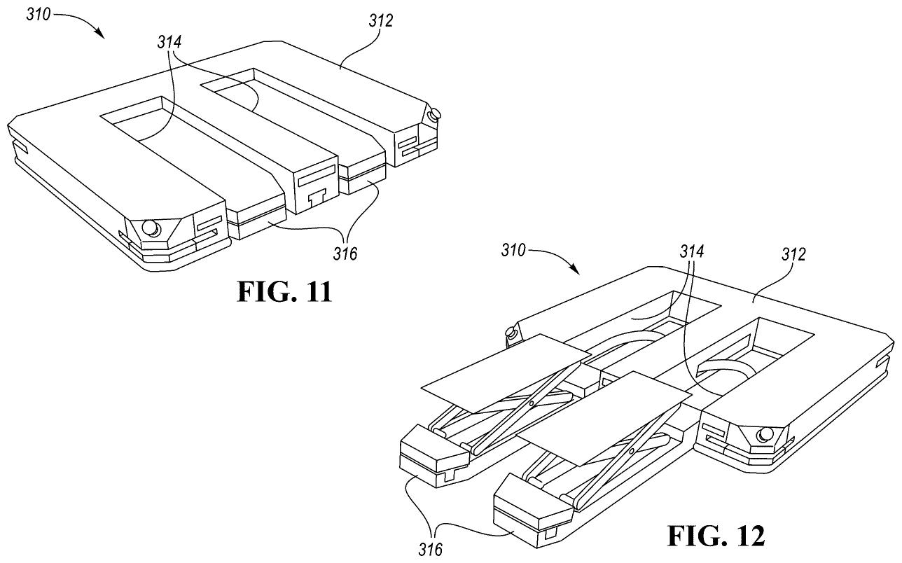

FIGS. 11 and 12 disclose an autonomous mobile robot or AMR 310. The AMR 310 includes a base portion 312 having a pair of recesses 314 spaced apart from one another and opening forwardly of the base portion 312. A retractable lift 316 is positioned in each recess 314. Each retractable lift 316 includes a lift mechanism, such as the scissor jack illustrated. The AMR 310 can move each retractable lift 316 in and out of the respective recess 314, toward and away from the base portion 312, as shown in FIGS. 11 and 12, via hydraulics, electric motors, etc. Wheels (not visible) may support each of the retractable lifts 316. The retractable lifts 316 may remain stationary while the base portion 312 moves away from the retractable lifts 316 and pushes them out of the recesses 314.

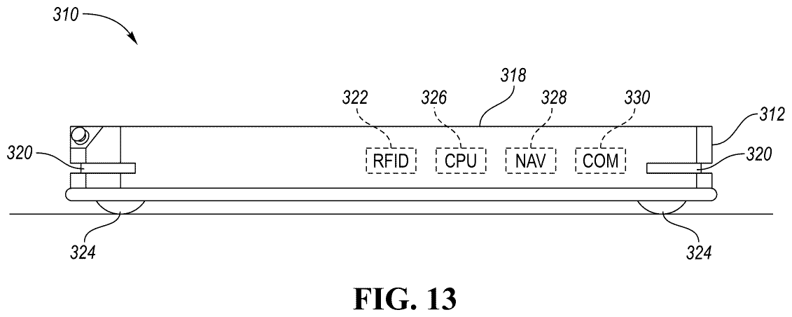

FIG. 13 is a schematic, simplified side view of the AMR 310. An upper platform 318 is supported by the base portion 312 and at least one weight sensor, such as a plurality of load cells 320. Any weight on the platform 318 is measured by the load cells 320. An RFID reader 322 is also mounted in the base portion 312 and is configured to read an RFID tag mounted to a pallet supported on the AMR 310. The AMR 310 includes a computer 326 including at least one processor and at least one storage storing instructions which when executed by the at least one processor cause the AMR 310 to perform the functions described herein.

As is known, the AMR 310 also includes navigation hardware 328, such as LiDAR, ultrasonic sensors, radar, wheel odometry sensors, and cameras for recognizing landmarks in the warehouse (such as QR codes or reflective markers or other fiducials).

The plurality of load cells 320 and the RFID reader 322 communicate with the computer 30, e.g. via wireless communication module 330 (wifi, Bluetooth, cell data, etc). The AMR 310 includes one or more batteries for powering the wheels 324, sensors, and computer 326.

Wheels 324 support the base portion 312 and are powered to drive and steer the AMR 310 about the warehouse. The wheels 324 could be hub motors. The warehouse would include numerous AMRs 310 as described herein.

### Autonomous Mobile Robot in the Warehouse

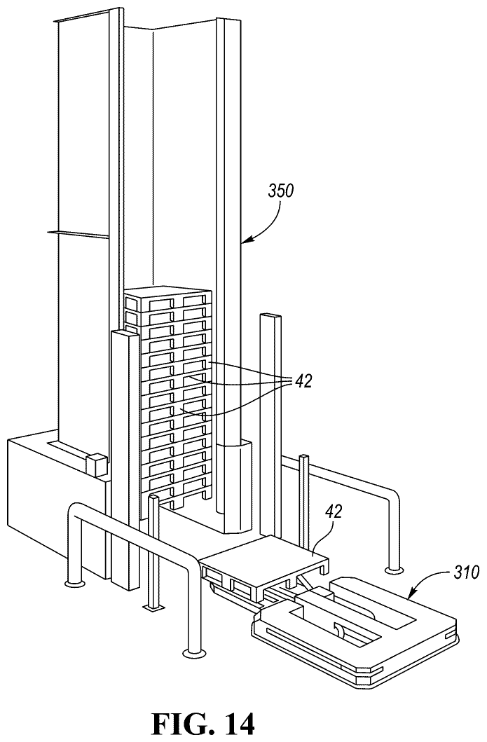

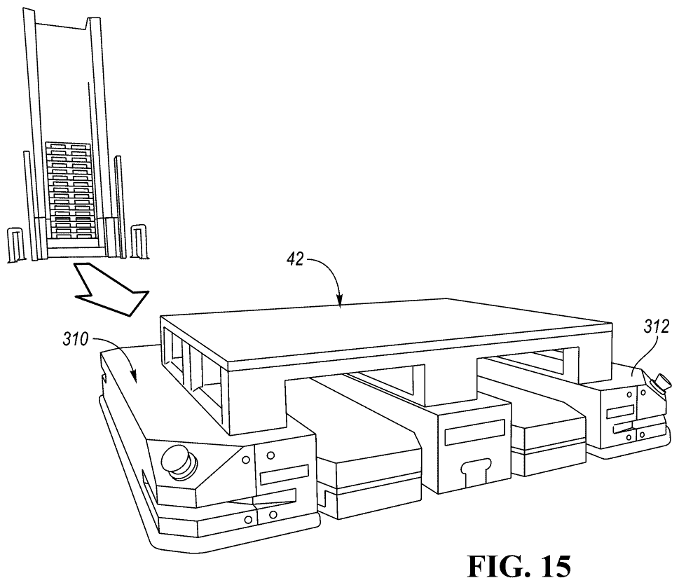

Referring to FIG. 14, the AMR 310 may first retrieve one or more pallets 42 from a pallet dispenser 350. As shown in FIG. 15, the pallet 42 is supported on the base portion 312. The RFID reader 322 on the AMR 310 reads an RFID tag on the pallet 42, if present, to retrieve a pallet id associated with the pallet 42. There may be more than one pallet dispenser 350 in the warehouse, where some dispense full size pallets, some dispense half pallets, some dispense keg pallets, and/or some dispense other types of pallets.

The pallet 42 includes a deck supported by columns (e.g. nine columns). Runners may connect the columns in groups of three, as is known. The columns and runners are supported on the upper platform 318 of the base portion 312 of the AMR 310.

### Autonomous Mobile Robot With Layer Picks

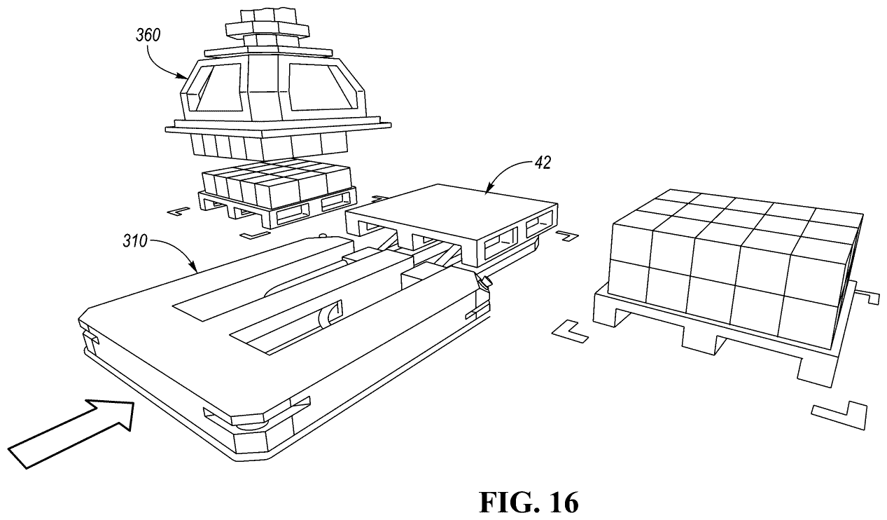

Referring to FIG. 16, the AMR 310 may then bring the pallet 42 to a layer pick station. The retractable lifts 316 lift the pallet 42 up from the base portion 312. The retractable lifts 316 are then extended from the 312, either moving the retractable lifts 316 and pallet 42 away from the base portion 312 or moving the base portion 312 away from the retractable lifts 316 and pallet 42. The retractable lifts 316 then lower the pallet 42 to the floor and are retracted back into the AMR 310, which then is free to perform another task, such as taking a pallet 42 that has already received its layer picks.

Optionally, in accordance with a pick list associated with that pallet 42, and under control of the computer 30, the pallet 42 may first be loaded with one or more layers of items 44, wherein each item in the layer is associated with the same SKU at a layer pick station 360. Each layer only contains items 44 of the same SKU, but each layer can be associated with a different SKU. As is known, the SKUs in the layer are typically placed on the pallet 42 all at once.

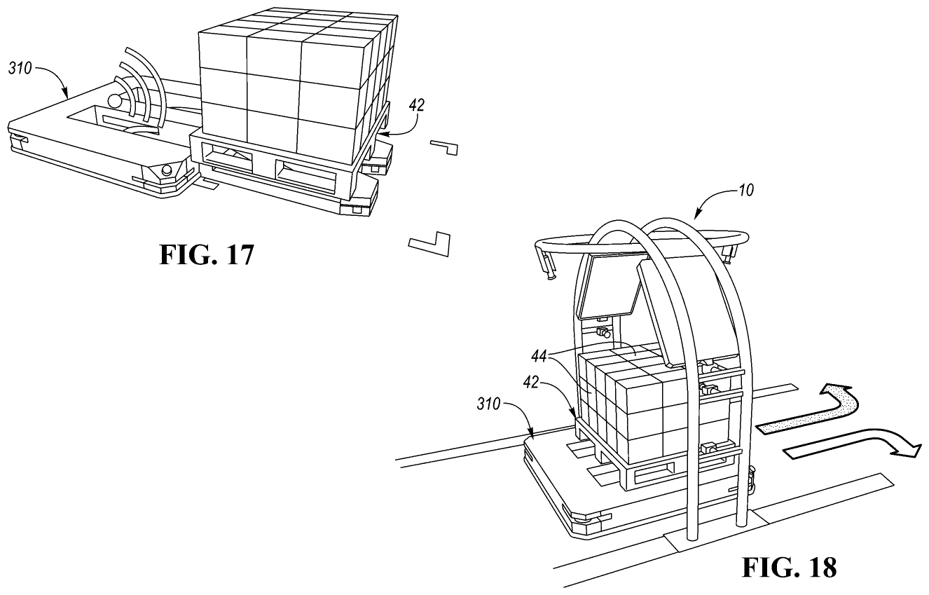

The AMR 310 (or a different AMR 310) may then retrieve the pallet 42, with the loaded layer picks as shown in FIG. 17, again reading the RFID tag on the pallet 42. The AMR 310 may also weigh the items 44 and pallet 42. The computer 30 and/or the AMR 310 may compare the weight of the items 44 (after subtracting the pallet 42) to an expected weight of the items 44. If the weights are off by more than a threshold, then the AMR 310 takes the pallet 42 and items 44 to a QC station for correction.

If the weight matches within a threshold (or if weight is optionally not checked), the AMR 310 may then bring the loaded pallet 42 through a validation station 10 as shown in FIG. 18. The validation station 10 may validate the items 44 on the pallet 42 as before and communicate the result to the AMR 310. The AMR 310 responds to an error message from the validation station 10 by taking the items 44 and the pallet 42 to a QC station for correction. The AMR 310 responds to a positive validation from the validation station 10 by taking the items 44 and the pallet 42 to the loading dock (or other staging area prior to loading).

If the validation is an interim validation (i.e. performed when it is known that the pallet 42 is not complete), then the AMR 310 responds to an error message from the validation station 10 by again proceeding to a QC station for correction, and the AMR 310 responds to a positive validation from the validation station 10 by proceeding to the next pick station to receive more items 44 on the stack.

If the validation is performed after a layer pick, the computer 30 knows that it is validating a layer pick, i.e. all the SKUs in that layer (or each of more than one layer) should be the same. The computer 30 can use this knowledge to increase the accuracy of the validation, i.e. by presuming that a SKU identified in a layer pick that does not match the SKUs of the other items in that same layer is incorrect. The computer 30 may ignore a mismatched identified SKU in a layer pick, for example, if the confidence of the identification of the mismatched SKU was below a threshold.

It should be noted that the interim validations can be performed after layer picks and/or periodically after some manual picks.

### Autonomous Mobile Robots With Interim Validations

With the use of the AMR 310 (instead of worker-operated equipment) and the small footprint validation station 10, it is practical to perform one or more interim validations during the loading of the pallet 42. As explained above, there are additional benefits to performing interim validations of a full-size pallet 42 (i.e. validating items 44 that will later be hidden), but the interim validations could be used with a half pallet 42 as well. Layer picks can be validated, but of course validation of individual item 44 picks (such as by hand) would benefit even more from validation because they are more likely to have an error.

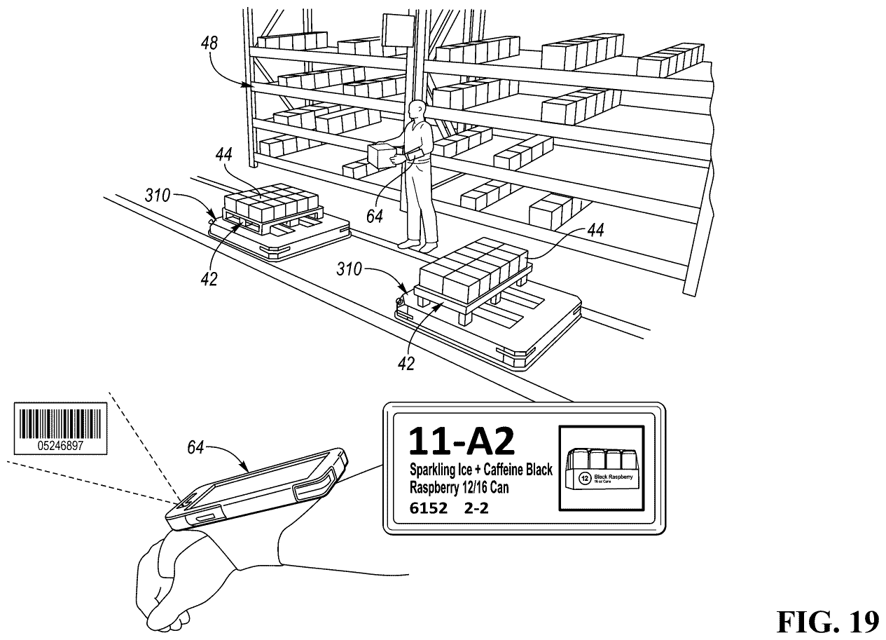

FIG. 19 shows a plurality of AMRs 310 in a manual pick lane in the warehouse. Each AMR 310 brings a pallet 42 to a position proximate a bay of one of the shelves 48 from which the pallet 42 needs at least one item 44 to fulfill its assigned pick list. The AMR 310 (or computer 30) communicates to the closest worker via a mobile device 64 carried by or mounted to the worker. In the example shown in FIG. 19, the mobile device 64 is secured to each worker's wrist. Each mobile device 64 may have a user interface, such as a touch display, speaker, and/or microphone. Each mobile device 64 also includes a wireless communication circuit (such as Bluetooth, wifi, cell data, etc) for communicating with the AMR 310 and the computer 30. The mobile device 64 may optionally also include a barcode scanner.

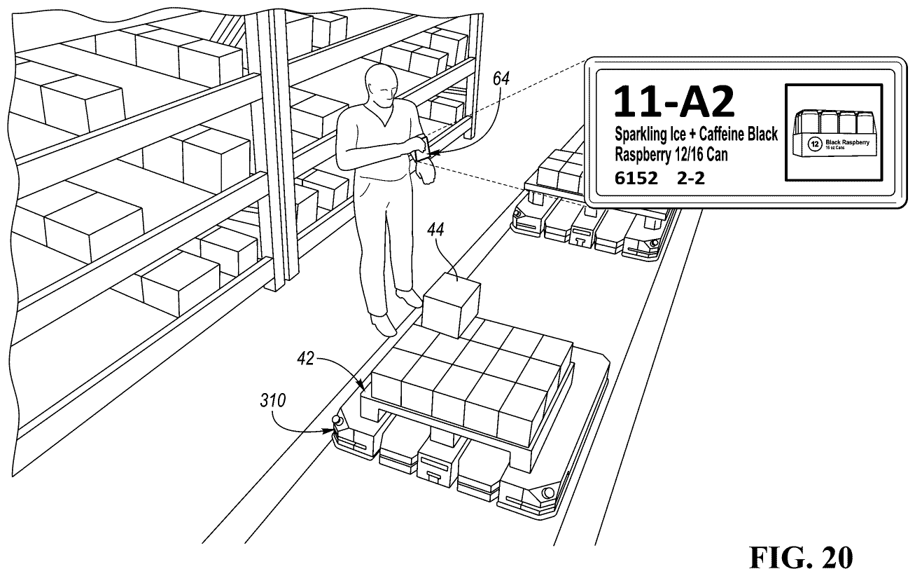

Referring to FIG. 20, the worker places the item(s) 44 on the pallet 42. The AMR 310 weighs the pallet 42 first to confirm that the worker placed the right number of items 44 on the pallet 42. Optionally, the AMR 310 determines if the weight of the additional item(s) 44 is within a threshold of an expected weight of the desired SKU(s), i.e. whether the weight indicates that the wrong SKU(s) were placed on the pallet 42.

If the AMR 310 detects an error, then the worker is alerted via the mobile device 64. After the AMR 310 confirms that the right number of items 44 have been placed on the pallet 42 (or optionally, if weight is not checked), the AMR 310 again travels through a validation station 10 (e.g. FIG. 18) to confirm that the correct items 44 have been placed on the pallet 42 (if not, goes to QC; if so, then continues to next pick).

### Autonomous Mobile Robot to Carry Kegs

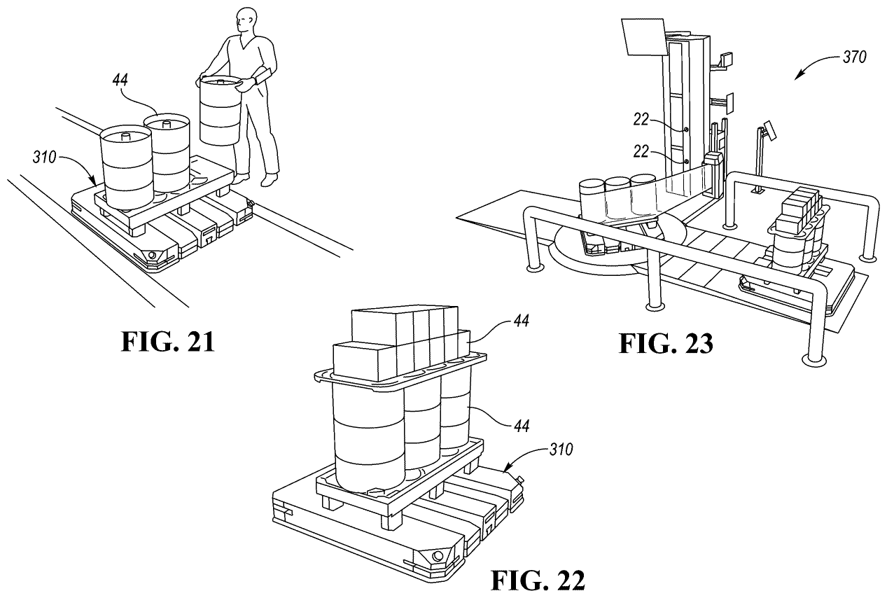

FIG. 21 shows that the AMR 310 can also be used with a pallet 42 can be used to carry larger items 44, such as kegs. The AMR 310 may again travel through the validation station 10 (or validation station 110 or validation station 210) to validate that the correct kegs have been picked.

Referring to FIG. 22, additional items 44, such as packages (such packages of beverage containers) can be stacked on the kegs, optionally with a slip sheet or intermediate board in between for stability. Referring to FIG. 23, the AMR 310 may then bring the loaded pallet to a wrapper 370. The AMR 310 may drive onto the turntable of the wrapper 370 to enable the wrapper 370 to rotate the AMR 310, pallet 42 and items 44 while stretch wrap is placed around. The wrapper 370 may also include cameras for imaging the items 44 on the pallet 42 while the turntable rotates the pallet 42 and the computer 30 performs the validation comparison to the pick list prior to wrapping. The AMR 310 may then bring the wrapped, loaded pallet 42 to a loading dock or staging area.

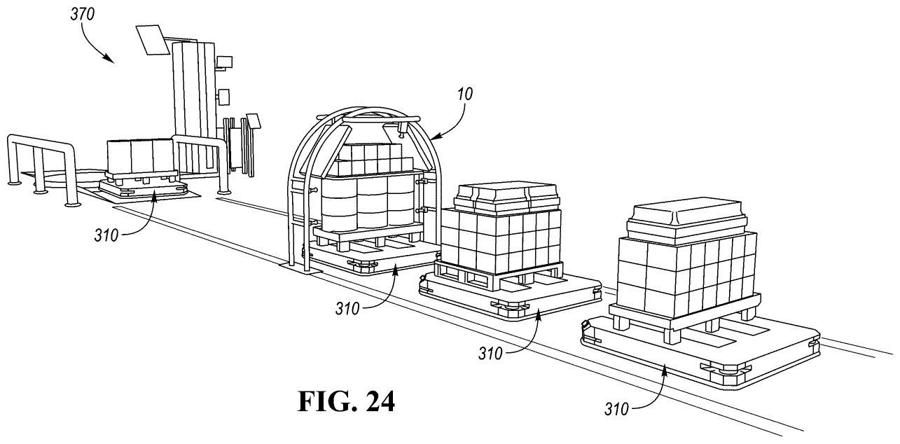

FIG. 24 illustrates a plurality of AMRs 310, each bringing a different type of pallet (keg pallet, full-size pallet, half pallet) through a validation station 10 and then onto a wrapper 370 (if the load is validated).

### Wrappers in Parallel

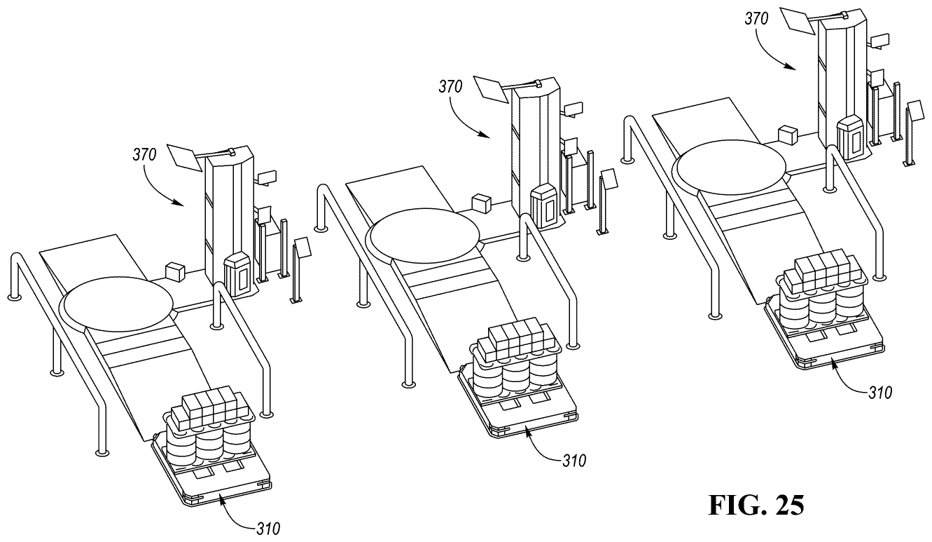

As shown in FIG. 25, multiple wrappers 370 can be operated in parallel. Each AMR 310 may be directed (e.g. by computer 30) to the available wrapper 370 (or wrapper 370 with the shortest line). A validation station 10 (FIG. 24) or validation station 110 may be positioned in front of each wrapper 370 or there can be two or three wrappers 370 for each validation station 10 because wrapping takes more time than validation.

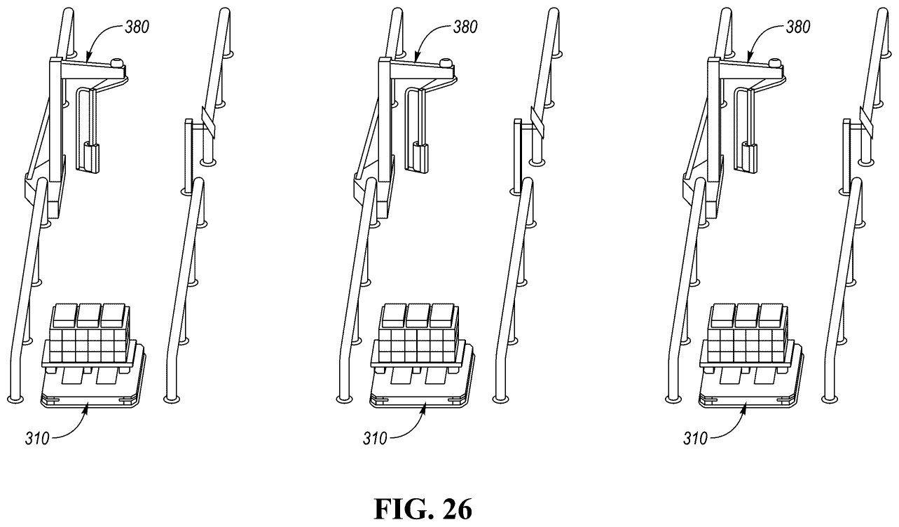

FIG. 26 shows a plurality of wrappers 380 in parallel. In this example, the wrappers 380 do not include turntables, but include an arm that moves the stretch wrap around each load as the AMR 310 stops briefly in front of each wrapper 380. The wrappers 380 are generally faster than the wrappers 370. Again, a validation station 10, 110 may be positioned in front of each wrapper 380 or there can be one validation station per two or three wrappers 380.

### Autonomous Mobile Robot at the Loading Dock

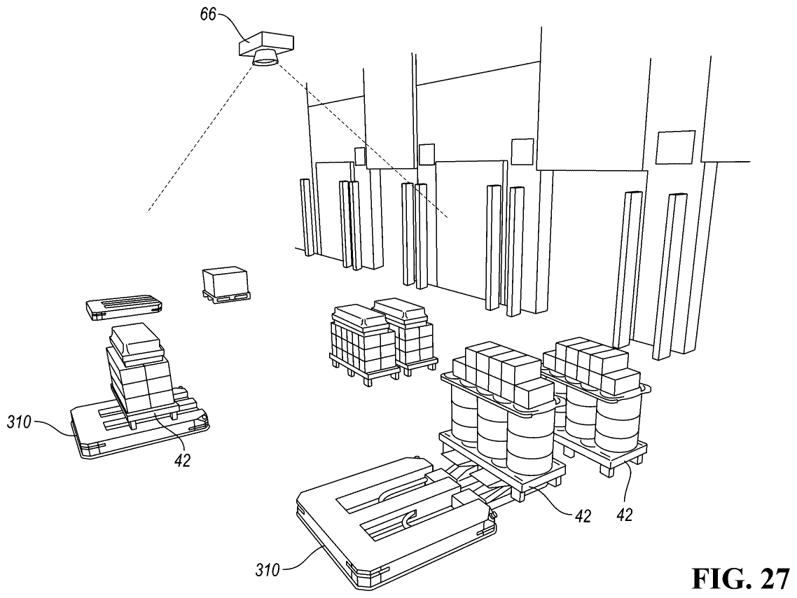

Referring to FIG. 27, after a final validation (and after wrapping, if applicable), the AMRs 310 bring the loaded pallets 42 to loading docks, or a staging area proximate loading docks. The AMRs 310, as controlled by the computer 30, arrange the pallets 42 proximate loading docks to which the pallet 42 is assigned. The pallets 42 may also be arranged by the AMRs 310 in an assigned loading sequence.

In an optional implementation, the ability of the AMRs 310 to place pallets 42 in uniquely-identifiable locations in the warehouse can be used in place of RFID tags on the pallets 42. As is known, the location of each AMR 310 within the warehouse is known with fairly high precision based upon position determining sensors and fiducials in the warehouse. The location of each AMR 310 may also be determined by one or more overhead cameras 66.

An AMR 310 loads and validates a pallet 42 stacked with items 44 according to a pick list 40, as described above. The AMR 310 then places the pallet 42 in a particular location (or “slot”) on the floor proximate the loading docks. The slots may just be specific locations on the floor and may optionally be marked visually for the overhead camera 66. That particular slot is recorded by the computer 30, which associates that slot and that pallet 42 with the pick list that was used to load that pallet 42. Alternatively, the computer 30 just associates that slot and that pallet 42 with a particular loading dock/truck and a particular spot in a loading sequence for that truck. The AMR 310 then retrieves another empty pallet 42, loads the pallet 42, and places it in another slot associated by the computer 30 with another pick list. A plurality of AMRs 310 are doing the same.

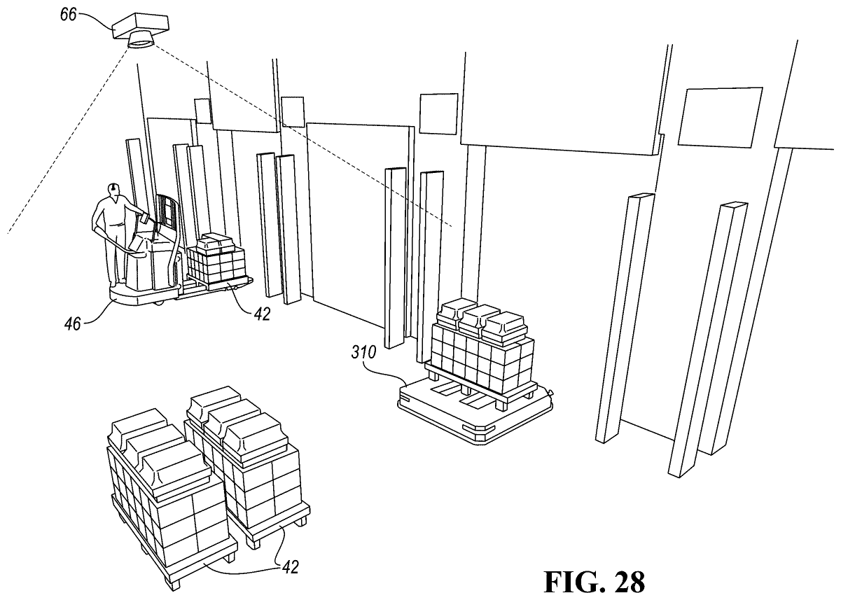

Referring to FIG. 28, when one or more staging areas are complete, i.e. complete truckloads, the loaded pallets 42 are loaded onto the associated trucks through the designated loading dock bay doors. This may be done with material handling equipment 46 (a walkie rider is shown), with the AMRs 310, or different AMRs more particularly designed to load trucks. The AMRs are directed by the computer 30 to retrieve specific pallets 42 and place them on assigned trucks in a sequence determined by the computer 30. The AMRs 310 can find the specific pallets 42 based upon the slots in which they were placed. Again, the slots may just be specific locations on the floor or may be marked visually for the overhead camera 66.

Referring again to FIG. 27, alternatively, or additionally, one or more overhead cameras 66 communicating with the computer 30 can track the locations of every pallet 42 in the staging area. If the trucks are loaded with material handling equipment without precise location features (or as a confirmation of the path of the AMRs 310), the overhead cameras 66 can track the path of each pallet 42 from its assigned slot to ensure that it is placed on the correct truck. Optionally, the one or more overhead cameras 66 also track the path of each pallet 42 to ensure that the pallet 42 is loaded in the right sequence (e.g. the pallets 42 that will be unloaded last are loaded first). If the computer 30 detects a pallet 42 being brought to either the wrong loading dock bay door or in the wrong sequence, an indicator at the door can turn red and/or audible alarms can be activated by the computer 30.

Optionally, the overhead cameras 66 can track the locations of the pallets 42 from beginning (empty pallet) to end (staging area and/or truck) to associate each pallet 42 with a pick list and to ensure that the correct pallets 42 are loaded on each truck, optionally in the correct sequence. Fiducials, such as markings on the floor, can assist the overhead cameras 66 tracking and locating the AMRs 310 and pallets 42. This end-to-end location tracking could be used instead of RFID tags on the pallets 42, or for warehouses where at least some of the pallets 42 do not include RFID tags.

### AMR Rotation and Camera Angles

The validation stations 10, 110, 210 each provide simultaneous imaging of all four sides of the stack of items 44 on the pallet 42. There may also be more than one camera on each side (or more than one set of cameras on each side) so that images at slightly different angles may also be captured, in case one of the images has less glare or is otherwise clearer. The plurality of cameras also enable a wider field of view while permitting the cameras to be located closer to the items 44 and the pallet 42.

Additionally, or alternatively, when used with the AMR 310 the validation station 10, 110, 210 could be controlled by the computer 30 to take a first set of images from all of the cameras 22, capturing all four sides of the stack of items 44. Then the AMR 310 rotates slightly (e.g. between three and ten degrees) and the validation station 10, 110, 210 captures another full set of images. This provides images from two angles of each side of the stack. The computer 30 analyzes SKUs from each image and discards the image of each side that identifies SKUs at a lower confidence level.

As another alternative, with the AMR 310, the number of cameras 22 on the validation station 10, 110, 210 could be reduced. At one extreme, only one camera (or one set of cameras) is provided on one vertical support or mounted overhead. The other structure would be eliminated. Instead, the AMR 310 communicates with the computer 30 so that the AMR 310 rotates to show each side of the stack to the single camera (or single set of cameras). All four sides could be captured after three ninety-degree rotations. Optionally, more than one image of each side could be captured at slightly different angles, i.e. at 0, 5, 90, 95, 180, 185, 270, and 275 degrees.

As another alternative, all but any two (or three) of the cameras 22 or set of cameras 22 in the validation station 110, 110, 210 are eliminated (which again may also permit elimination of some structure). Automatic rotation of the AMR 310 enables the cameras 22 on only two or three sides of the stack to capture all four sides of the stack (optionally, capturing each at slightly different angles), but fewer such rotations would be required.

In any embodiment where there is potentially relative rotation between the stack of items 44 and one or more cameras 22 (e.g. the items 44 are on an AMR or turntable that is rotating relative to the camera(s) or the camera(s) are rotating about the stack of items 44), it may be beneficial to capture more than one image of each side of the stack at slightly different angles (as mentioned above). The validation station 10, 110, 210 may analyze the images captured at slightly different angles of a side and compare the confidence levels of the inferred SKUs of the items 44 in the images. The SKUs that are inferred at a higher confidence level are used.

### Camera Tower

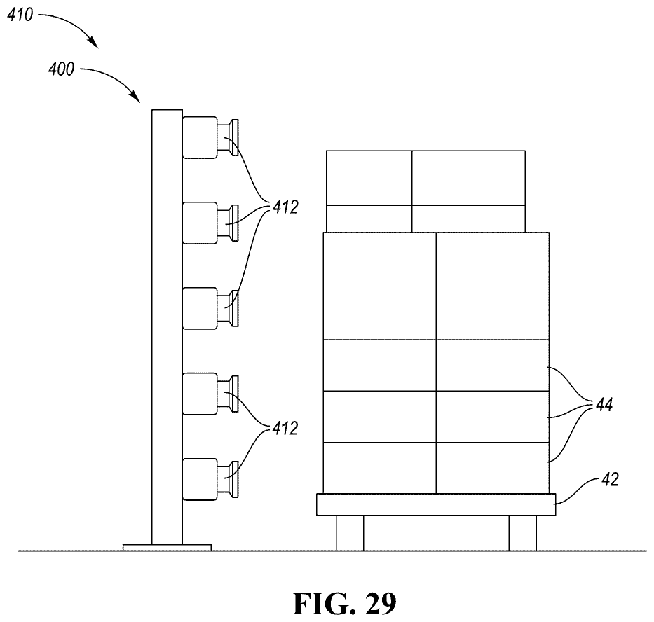

FIG. 29 shows a validation station 410 including a camera tower 400 having a plurality of cameras 412. The plurality of cameras 412 are spaced apart vertically and arranged substantially in a single vertical plane containing the optical axes of the plurality of cameras 412. In this example, there are five cameras 412, but 3 or 4, or more than 5 cameras could also be used. However, in this application, five cameras 412 provides a good balance of cost, complexity, and resolution. To reduce the footprint of the validation station 410, the cameras 412 are positioned very close to the items 44. For example, the plurality of cameras 412 (or at least a closest one of the plurality of cameras 412) are preferably less than two feet from the items 44, and more preferably approximately 1.5 feet from the items 44. The use of multiple cameras increases the number of pixels available and reduces lens distortion compared to using a single camera with a wide-angle lens. Further, the use of multiple cameras permits them to be very close to the items 44, thereby reducing the footprint of the validation station 410.

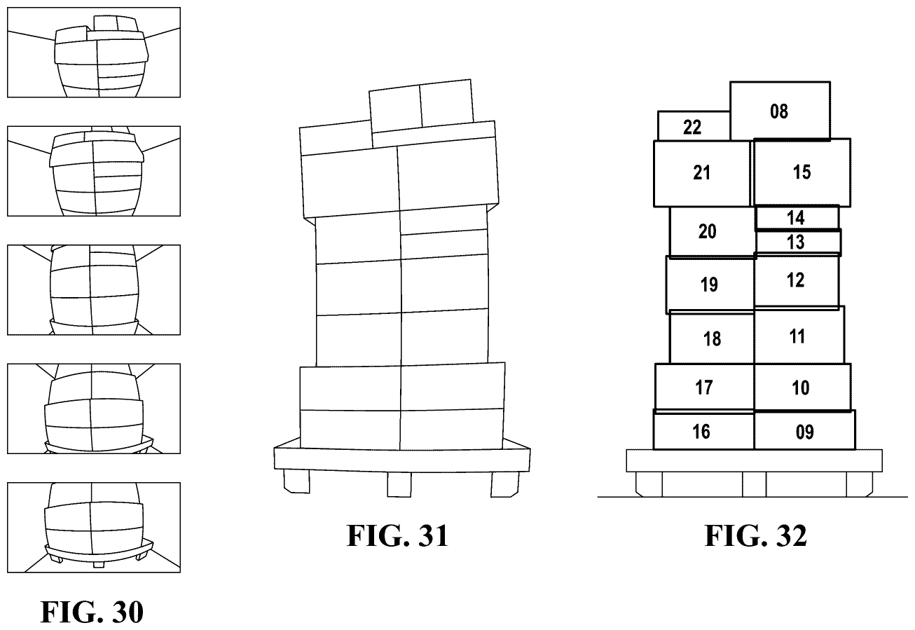

FIG. 30 shows sample images from the plurality of cameras of FIG. 29. The images overlap and there is still some lens distortion. The lens distortion is removed, and the images are stitched together to form the composite image of FIG. 31. The composite image of FIG. 31 is a high-resolution image of the items 44 on the pallet 42. The resolution is sufficiently high for the computer 30 to perform OCR and to read available barcodes.

The computer 30 then determines the bounding boxes for each of the items 44 as shown in FIG. 32. The computer 30 identifies the SKUs of each of the items 44 by analyzing the images of the items 44 using the at least one machine learning model 38 in a manner previously disclosed.

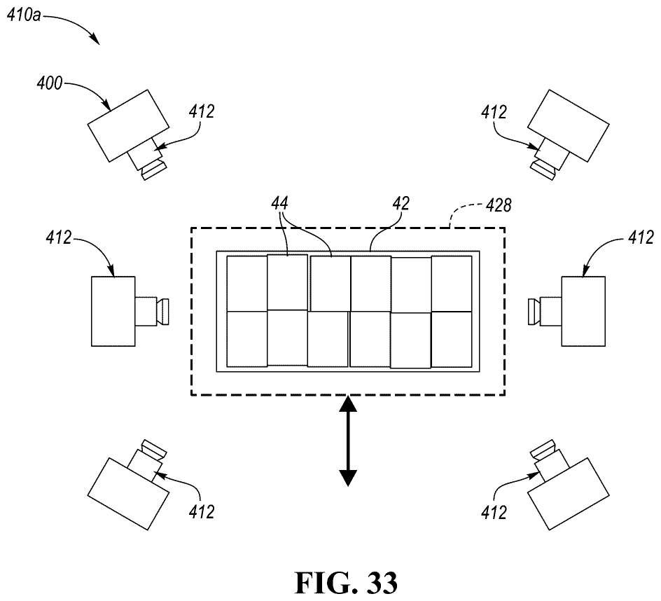

A more specific example of a validation station 410a using a plurality of the camera towers 400 is shown in FIG. 33. In FIG. 33, a half pallet 42 is shown with a plurality of items 44 stacked thereon. However, a full-size pallet could also be used. Two of the camera towers 400 are positioned very close to the items 44 (again, within two feet, and more preferably approximately 1.5 feet away) and directed toward the short ends of the stack on the pallet 42, with the optical axes of the cameras 412 oriented perpendicularly to the short ends of the pallet 42.

For example, if the pallet 42 is a half pallet, its dimensions would be approximately 19 inches to approximately 24 inches by approximately 40 inches to approximately 48 inches, including the metric 800 mm×600 mm. Thus, a front plane of the cameras of one tower would be between approximately 76 inches and approximately 96 inches from a front plane of the cameras of the other tower. One half pallet 42 is approximately 19 inches by approximately 47.5 inches. In such an implementation, the cameras of the camera towers 400 could be approximately 83 inches to approximately 96 inches from one another (so as to leave 18 to 24 inches between the front planes of the cameras and the ends of the pallet 42).

Two camera towers 400 are directed at oblique angles toward one long side of the pallet 42 while two more camera towers 400 are directed at oblique angles toward the other long side of the pallet 42. There is sufficient space between the camera towers 400 in each pair for the pallet to pass through into the position shown. The pallet 42 can be brought by material handling equipment into the validation station 410a in either direction (up or down in FIG. 33). The material handling equipment can remove the pallet 42 in either direction. The validation station 410a of FIG. 33 provides high resolution composite images of each of the four sides of the pallet 42 and items 44 stacked thereon. Again, these images are sufficiently high resolution that the computer 30 can perform OCR and can read barcodes on each of the items 44, where present. An optional weight sensing platform 428 on or in the floor in the validation station 410a can provide weight information to the computer 30.

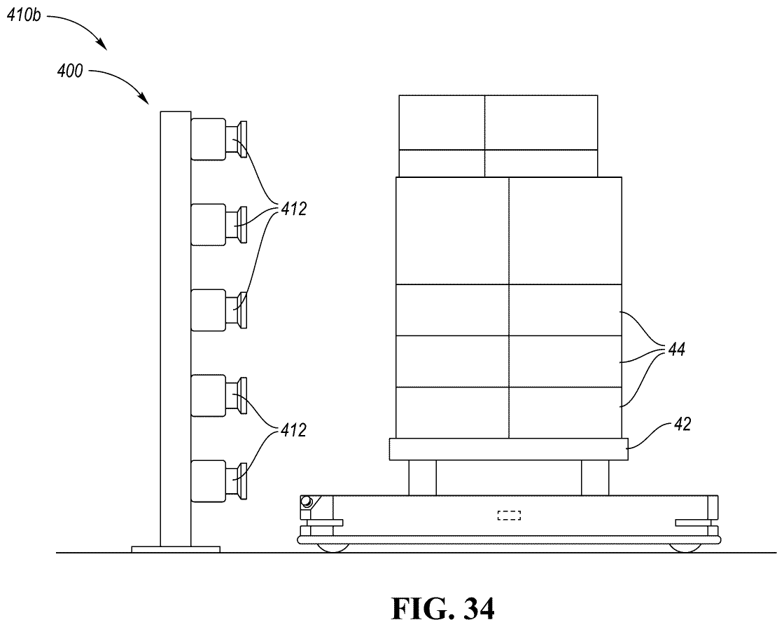

Another example of a validation system 410b for use with the AMR 310 using only a single camera tower 400, is shown in FIG. 34. Again, the cameras 412 are positioned very close to the items 44 (again, within two feet, and more preferably approximately 1.5 feet away). The AMR 310 communicates with the computer 30 so that the AMR 310 rotates to show each side of the stack to the camera tower 400. The computer 30 coordinates and controls the AMR 310 and camera tower 400. All four sides could be captured after three ninety-degree rotations. Optionally, more than one set of images of each side could be captured at slightly different angles, i.e. at 0, 5, 90, 95, 180, 185, 270, and 275 degrees, as described above.

As another alternative, two camera towers 400 could be used. The two camera towers 400 could be directed toward one another, i.e. oriented 180 degrees relative to one another, or they could be oriented 90 degrees relative to one another. Automatic rotation of the AMR 310 enables the two camera towers 400 to capture all four sides of the stack (again, optionally capturing each side more than once at slightly different angles), but fewer such rotations would be required. Again, the AMR 310 could have weight sensors and the weight information would be reported to the computer 30.

In any embodiment where there is relative rotation between the stack of items 44 and one or more camera towers 400 (e.g. the items 44 are on an AMR or turntable that is rotating relative to the camera tower(s) are rotating about the stack of items 44), it may be beneficial to capture more than one image of each side of the stack at slightly different angles (as mentioned above). The computer 30 may analyze the images captured at slightly different angles of a side, compare the confidence levels of the inferred SKUs of the items 44 in the images, and use the images that have the higher confidence levels.

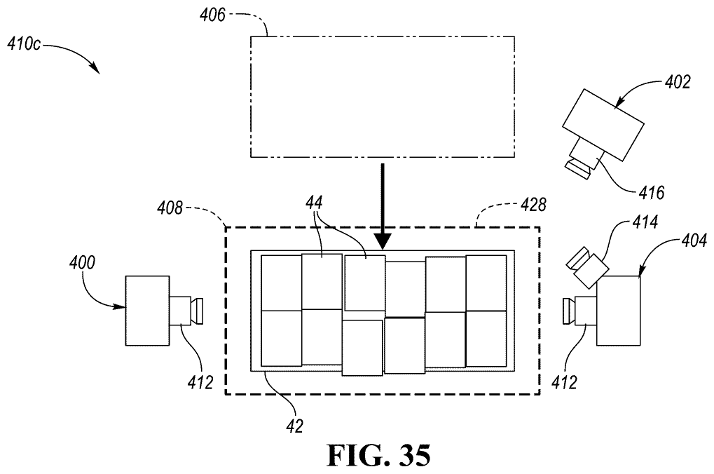

FIG. 35 shows the validation station 410c having the camera tower 400 positioned very near a main imaging area 408. A second camera tower 404 is positioned very near the opposite end of the main imaging area 408. Again, “very near” means that the cameras 412 would be within two feet, and more preferably approximately 1.5 feet, of the items 44. Again, with typical half pallets, a front plane of the cameras 412 of the first tower 400 would be between approximately 76 inches and approximately 96 inches from a front plane of the cameras 412 of the second tower 404. One half pallet 42 is approximately 19 inches by approximately 47.5 inches. In such an implementation, the cameras of the camera towers 400, 404 could be approximately 83 inches to approximately 96 inches from one another (so as to leave 18 to 24 inches between the front planes of the cameras and the ends of the pallet 42).

The second camera tower 404 is identical to the first camera tower 400, with the addition of a front camera 414 oriented at an oblique angle relative to the cameras 412 and directed toward an initial imaging area 406. The initial imaging area 406 is spaced approximately five to twenty feet from the main imaging area 408. A rear camera 416 is mounted to a rear tower 402 such that the rear camera 416 is oriented at an oblique angle to the rear long side on the main imaging area 408. The rear tower 402 is offset from a path defined by the initial imaging area 406 and the main imaging area 408. The initial imaging area 406 may be proximate, but just forward of, the rear tower 402.

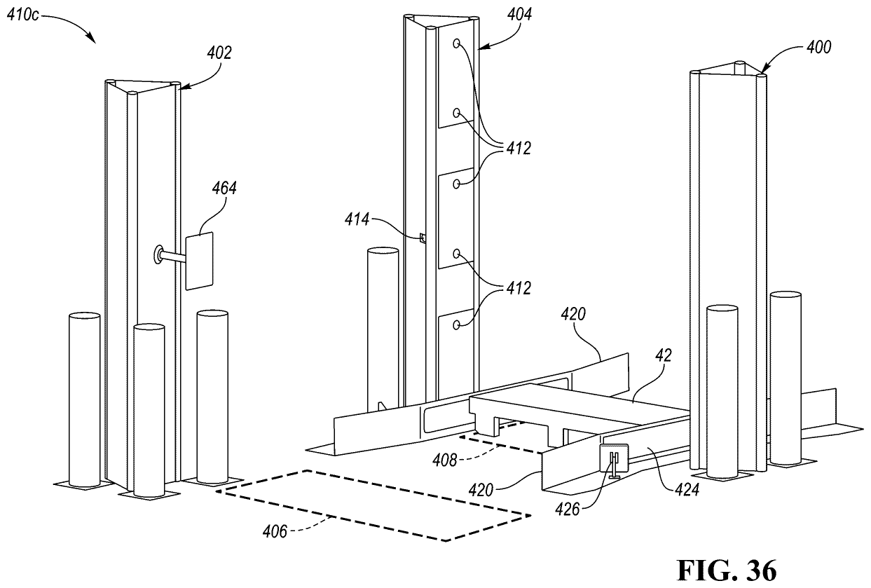

FIG. 36 is a first perspective view of the validation station 410c of FIG. 35. As shown, the first camera tower 400 faces the second camera tower 404, and each is positioned very near the ends of the main imaging area of 408. The optical axes of the cameras 412 of the first camera tower 400 and the second camera tower 404 are all in a single vertical plane. The front camera 414 of the second camera tower 404 extends at an oblique angle relative to the cameras 412 of the second camera tower 404 and is oriented at an oblique angle relative to a front a long side of the initial imaging area 406.

A mobile device 464 is mounted to the rear tower 402. The mobile device 464 is accessible by an operator of material handling equipment while a pallet 42 is in the initial imaging area 406. Thus, the initial imaging area 406 is proximate, but just forward of the rear tower 402.

Guide rails 420 are positioned between the first camera tower 400 and the main imaging area 408 and between the second camera tower 404 and the main imaging area 408. A center portion 424 of each guide rail 420 Is formed of plastic or some other radio transparent material. An RFID antenna 426 is positioned outward each center portion 424 to read an RFID tag on the pallet 42 in the main imaging area of 408. The guide rails 420 flare outward away from each other at each end and are closer to one another in the main imaging area 408.

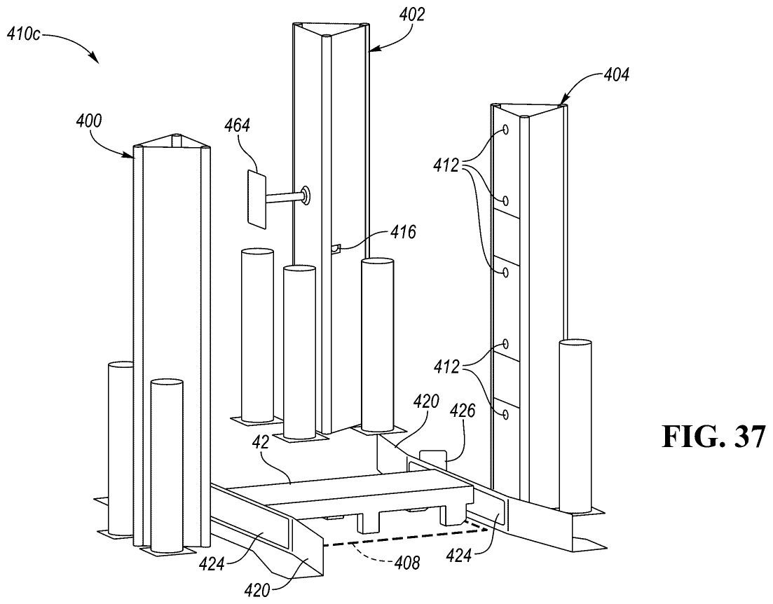

FIG. 37 is a second perspective view of the validation station 410c. The rear tower 402 includes a single rear camera 416 directed toward a rear long side of the main imaging area 408. More than one rear camera could also be used.

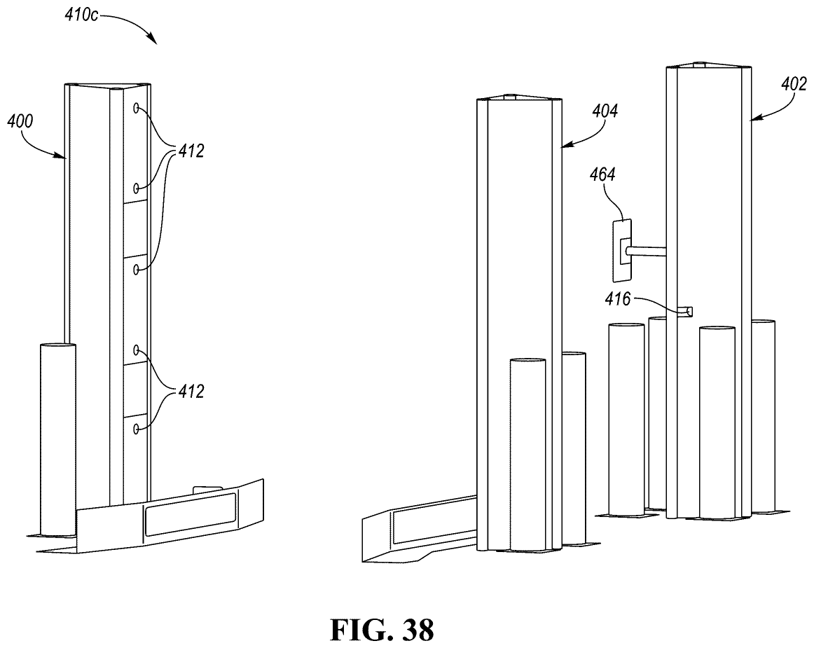

FIG. 38 is third perspective view of the validation station 410c. Again the plurality of cameras 412 from the first camera tower are directed to the area above the main imaging area 408.

Referring again to FIG. 36, in use a user brings the pallet 42 loaded with items (not shown in FIG. 36 for clarity) on material handling equipment, such as the pallet lift jack or walkie rider. The user initially stops at the rear tower 402, with the pallet 42 and items 44 in the initial imaging area 406. In this position, the front camera 414 of this second camera tower of 404 images the leading, front long side of the stack of items 44 on the pallet 42. During this time, the user accesses the mobile device 464 mounted to the rear tower 402. The mobile device 464 may read a barcode or QR code or text presented by the user indicating or corresponding to a pick list. The barcode, QR code, or text may be on a paper or may be on another mobile device carried by the user. Alternatively, the mobile device carried by the user may communicate with the mobile device 464 wirelessly such as via Bluetooth or NFC. Alternatively, if the pallet id (referenced by an RFID on the pallet 42) is already associated with a pick list, then reading a barcode, QR code, or text or otherwise indicating the pick list to the mobile device 464 is not necessary.

The user then places the pallet 42 in the main imaging area 408 and backs away. The camera tower 400 and second camera tower 404 then image the proximate sides (e.g. the short ends) of the stack of items 44 on the pallet 42 while the rear camera 416 (FIG. 37) images the remaining rear long edge of the stack. Optionally a weight sensor in or on the floor weighs the pallet 42 and items 44 and sends this weight to the computer 30.

In this embodiment, the images of the long edges may or may not be sufficiently high resolution to enable the computer 30 to perform OCR or to read barcodes on those package faces. However, they are sufficient for analysis using the machine learning models. The composite images taken of the ends of the stack by the cameras 412 on the camera tower 400 and the second camera tower 404 are processed to remove lens distortion, then stitched together to create a single high resolution composite image of each end of the stack. These images are high resolution such that the computer 30 can perform OCR and read barcodes on the items 44.

After imaging, the computer 30 infers the SKUs of each of the items 44 on the pallet 42 (as explained herein) and compares the quantity of each SKU with the quantities of those SKUS on a pick list associated with that pallet 42 (the pick list indicated by the user to the mobile device 464). The computer 30 indicates to the user whether the items 44 on the pallet 42 match the pick list or whether there are errors that need to be corrected (e.g. that the user should take the pallet 42 to a QC station).

### Dewarping and Slope Calculation

In any of the validation stations disclosed herein or otherwise, it may be beneficial to determine an angle of the items 44 relative to the camera and to correct for the resultant keystone distortion.

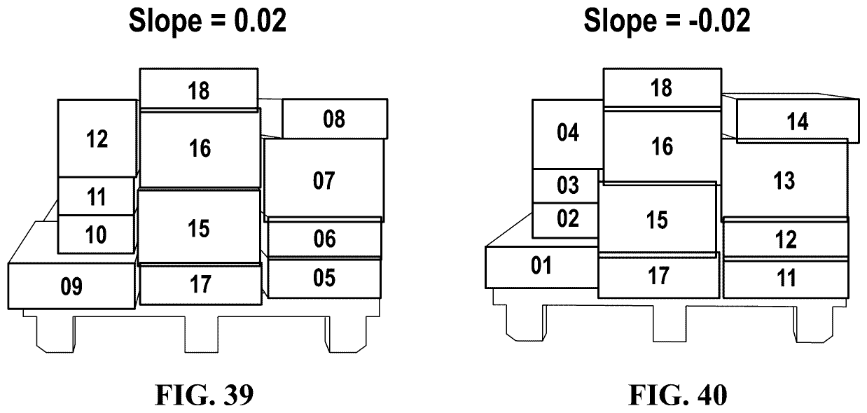

Referring to FIGS. 39 and 40, the computer 30 analyzes these images to determine a “slope” formed by the bottom edges of the bottom items 44 in the stack (this is packages 09, 17, and 05 in FIG. 39 and packages 01, 17, and 11 in FIG. 40). This slope is based upon a relative rotational position between the stack of items 44 and the camera 22 that captured that image. The computer 30 determines the slope (representative of an angle of the face of the stack relative to the camera) and identifies the SKUs in the images of FIGS. 39 and 40 (i.e. a plurality of images at different angles), each at an associated confidence level. The computer 30 determines which slope (angle) identified SKUs at the highest confidence level. Subsequently, the computer 30 determines the slopes of each of the plurality of images taken of the same side of the stack and only uses the image having the slope closest to the one previously determined to produce the highest confidence. Alternatively, the computer 30 may control the relative rotation of the stack and the camera(s) to capture images at the desired angle (slope).

In a particular implementation, it may be that the highest confidence occurs when the stack is “square” to the camera (i.e. the faces of the items 44 are perpendicular to the camera). In another implementation, depending on lighting and avoiding glare, it may be that the highest confidence occurs when the stack is angled slightly away from being perpendicular to the camera.

After having determined the best angle(s) for capturing images, the computer 30 can control the relative rotation (e.g. controlling the AMR, the turntable or the position of the camera(s)) and time the image capture (or capture many images and only keep those at the relevant times) based upon the known desired angles.

For example, the computer 30 could measure the times at which the best angles will occur during the rotation and use these times to capture the images or keep the images at those times. The computer 30 could augment the expected times based upon the weight of the pallet and items (i.e., heavier loaded pallets may be rotated more slowly or accelerate more slowly). The computer 30 could receive a signal indicating the instantaneous RPM of the turntable (or AMR 310) to anticipate when the desired angles will occur. The computer 30 could create a function that determines when each side should be flat (or otherwise ideal) based upon the weight and/or RPM.

The computer may use a detector to determine when the pallet is moving. If the confidence and slope do not find a flat face (or otherwise ideal angle), the computer uses the frame closest to the expected time. The computer may use a frame timestamp feature from Basler.

### Depth Data and Normal Vector

For any of the embodiments described herein, the computer 30 may determine depth data of the image and/or the computer 30 may determine a normal vector for each package face that is visible in one image. This may be used by the computer 30 to prevent double-counting a single package. This may also be used by the computer 30 to determine that the two package faces in one image are two package faces of the same package, such that SKUs, package type, and/or brand of each package face could be inferred, with the computer 30 choosing to use the inference with a higher associated confidence level.

For example, the computer 30 uses a known algorithm that uses the shape of each package face in the image to determine a normal vector. A rectangular package face will have keystone distortion in the image that is based upon the difference between the normal vector to the package face and the optical axis of the camera (after also correcting for lens distortion). By comparing the keystone-distorted package face to a regular rectangle, the normal vector is calculated by the computer 30.

If two adjacent package faces in a single image appear to have normal vectors that are orthogonal to one another, then they are determined by the computer 30 to be different package faces of the same package. If another camera is already imaging the other package face, the computer 30 discards one of the package faces (e.g. the one whose normal vector is furthest from parallel to the optical axis of the camera that took the image). Alternatively, the camera also analyzes the second package face to determine a SKU, package type, and/or brand with the computer 30 choosing to use only the inference with a higher associated confidence level, so that the computer 30 does not double-count the package when comparing the inferred SKU to the pick list.

The computer 30 may also dewarp (i.e. remove keystone distortion, or other distortion of the image of the package face because of the angle of the image) based at least in part on the slope calculation and/or based upon the normal vector. By removing the keystone distortion or other image distortion, the same at least one machine learning model 38 can be used in any of the validation stations disclosed herein (and others). Removing the keystone distortion improves the inference and makes the inference more consistent across the different types of validation stations.

### High Speed Wrapper/Conveyor Stability

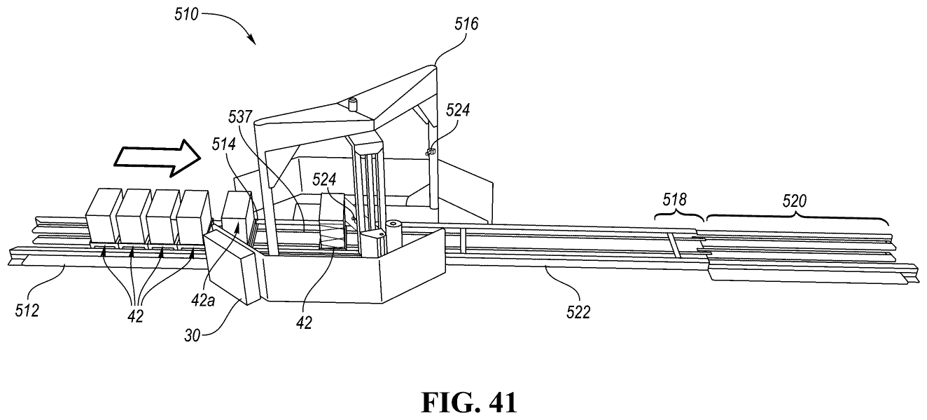

Referring to FIG. 41, a high-speed wrapper system 510 (or automated pallet wrapper) according to one embodiment includes an infeed conveyor 512 leading to a transfer conveyor 514, which in turn leads to a wrapper conveyor 537 within a wrapper 516. The wrapper conveyor 537 leads to an outfeed queue conveyor 522 which in turn leads to a weigh conveyor 518, which in turn leads to an outfeed conveyor 520. The loaded pallets 42, including pallet 42a, are carried on the infeed conveyor 512 to the transfer conveyor 514, then to the wrapper conveyor 537, then to the weigh conveyor 518 and then to the outfeed conveyor 520. The pallet 42a is shown on the transfer conveyor 514. The weigh conveyor 518 includes a scale that can measure the weight of a loaded pallet supported on the weigh conveyor 518. The weight is received by the computer 30.

Many different configurations of the conveyors are possible, with or without the wrapper 516. One or more cameras 524 may be mounted to the wrapper 516, either on the static structure of the wrapper 516 or the rotating arm carrying the wrap or both (as shown). The cameras 524 are directed toward the wrapper conveyor 537 so that they can image the packages on the pallet 42a on the transfer conveyor 514. The images from the one or more cameras 524 are received by the computer 30. The images from the one or more cameras 524 may be used by the computer 30 with the machine learning models to infer the SKUs of the packages (as before) and may be used to detect rotation of a pallet and/or objects.

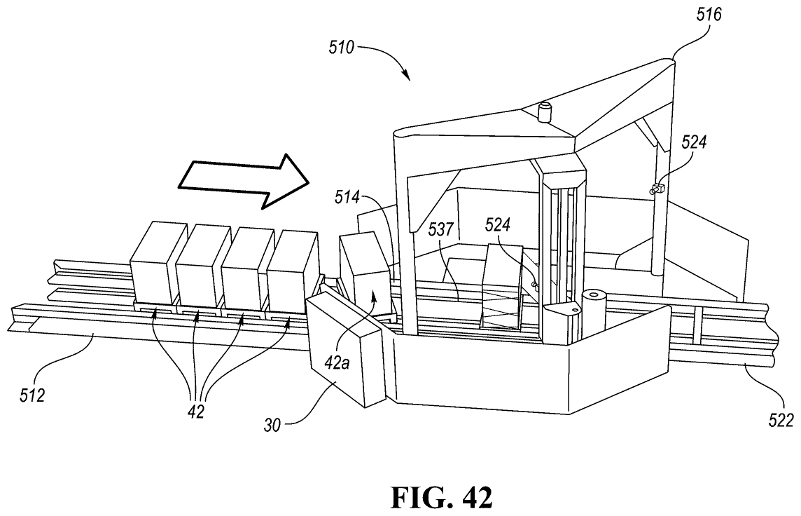

In FIG. 42, the pallet 42a on the transfer conveyor 514 has rotated somewhat about a vertical axis. This happens occasionally when one of the leading legs of the pallet 42a engages the transfer conveyor 514 and the other leading leg of the pallet 42a does not. The transfer conveyor 514 then pulls the one leading leg forward but not the other, which causes the pallet 42 to rotate about its vertical axis. Often, this causes the loaded pallet 42a to tip over. When this happens, the high-speed wrapper system 510 must be shut down while the spilled containers loaded on the pallet 42 are picked up.

In the example high-speed wrapper system 510, one or more of the cameras 524 captures images of the pallet 42a (and/or the packages on the pallet). The computer 30 receives these images. The computer 30 analyzes the images to detect rotation by the pallet 42a and/or its load about a vertical axis. If rotation above a certain threshold is detected, the computer 30 commands the transfer conveyor 514 to stop. Alternatively, the computer 30 commands the transfer conveyor 514 and the infeed conveyor 512 to stop. More generally, the computer 30 commands the conveyor onto which the pallet 42a is being transferred to stop, and optionally also commands the conveyor or conveyors leading to that conveyor to stop (downstream conveyors could continue). The conveyor or conveyors are stopped before the pallet 42a tips over. A user then adjusts the position of the pallet 42a and restarts the high-speed wrapper system 510. This saves the user a significant amount of time and prevents potential damage to the packages on the pallet 42a.

The computer 30 could take action to prevent tipping (e.g. stopping one or more conveyors) based upon: a change in the orientation of the load on the pallet (and/or the pallet) that exceeds a threshold, a rate of change in the orientation of the load and/or the pallet that exceeds a threshold, or simply an angle of the load and/or the pallet (e.g. the angular difference between the normal vectors of the leading package faces and the intended direction of travel of the pallet are above a threshold). Alternatively, the computer 30 could monitor all three of these and stop the conveyor(s) if any one of them exceeds its associated threshold. The angular difference between the normal vectors of the leading package faces and the intended direction of travel of the pallet can be determined in a single image.

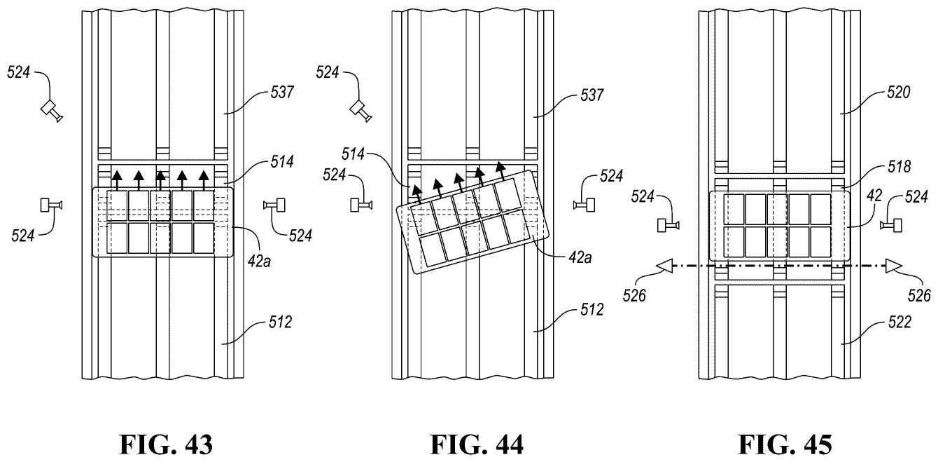

FIGS. 43 and 44 are schematic overhead views of the infeed conveyor 512, the transfer conveyor 514, and the wrapper conveyor 537 as the pallet 42a is moving from the infeed conveyor 512 to the transfer conveyor 514. In FIG. 43, the pallet 42a transfers correctly from the infeed conveyor 512 to the transfer conveyor 514. In FIG. 44, the pallet 42a has rotated about its vertical axis during the transition from the infeed conveyor 512 to the transfer conveyor 514.

At least one of the cameras 524 captures a series of images of the pallet 42a and/or the packages thereon as the pallet 42a moves along the infeed conveyor 512 and from the infeed conveyor 512 to the transfer conveyor 514. As explained above, the computer 30 calculates the normal vector for visible faces of the packages on the pallet 42a for each of the images. If the normal vectors rotate a sufficient amount in a certain amount of time, the computer 30 shuts down one or more of the conveyors. Optionally, the computer 30 stops one or more of the conveyors if any one of the normal vectors of any one of the packages rotates at a sufficient rate, which could indicate either that the pallet 42a is rotating or that at least one package is falling. If a package falls, that can cause a pallet 42a to tip over on the conveyors, so the conveyors would be stopped if at least one package is detected as falling or fallen. Optionally, the computer 30 only stops one or more conveyors if two or more normal vectors rotate at a sufficient rate. Optionally, the computer 30 only stops one or more conveyors if two or more normal vectors rotate generally together at a sufficient rate (i.e. within a threshold of the same rotational velocity of one another).

As an alternative, the computer 30 may in a sequence of images determine the bounding boxes (see, e.g. FIG. 32) of each of the package faces on the leading face of the stack of packages on the pallet 42a. If in the sequence of images, the computer 30 determines that the bounding boxes of some package faces are moving faster (or further over the sequence) than other package faces, the computer 30 determines that the pallet 42 is rotating and the computer 30 shuts down one or more conveyors as explained above. As another option, the bounding boxes in a sequence of images detects that at least one package has fallen or is falling, and the conveyor(s) are stopped in response. As yet another option, one or more microphones can supply an audio signal to the computer 30, which analyzes the sound using a machine learning model. If the computer 30 detects a sound of a package falling off the pallet 42a, then the computer 30 stops the conveyors.

For example, if the camera 524 is substantially facing the leading faces of the packages on the pallet 42a, the computer 30 may determine that the package faces of the packages on the left side of the pallet 42a are moving faster than the package faces of the packages on the right side of the pallet 42a. The computer 30 therefore determines that the pallet 42a is rotating and shuts down one or more conveyors to prevent the pallet 42a from tipping.

Alternatively, two or more cameras 524 may face the package faces on the short ends of the pallet 42a (package faces generally parallel to the direction of travel of the pallet 42a). One camera 524 faces the left side of the pallet 42a and one camera 524 faces the right side of the pallet 42a. The computer 30 calculates a rate of movement of the bounding boxes determined in the sequence of images for the left side and the rate of movement of the bounding boxes determined in the sequence of images for the right side. The computer 30 compares the rate of movement of the left side of the pallet 42a to the rate of movement of the right side of the pallet 42a. If the difference exceeds a threshold, the computer 30 shuts down one or more conveyors, as explained above. In the example of FIG. 44, the right side of the pallet 42a moved faster than the left side of the pallet 42a, indicating rotation of the pallet 42a about its vertical axis. When the computer 30 detects this difference, the infeed conveyor 512 and transfer conveyor 514 (or more) are stopped. This could be implemented at the junction of any two conveyors.

Optionally, in place of any one of the cameras 524 in FIGS. 41 to 44, there could be a camera tower 400 (e.g. FIG. 34) with multiple cameras 412 on each side of the loaded pallet 42a. As another option, the cameras 524 (either the camera 524 directed toward the leading face or the pairs of cameras 524 directed toward the short edges) could be repeated and spaced along the conveyor line every two or three feet from the infeed until the loaded pallet 42a is wrapped. The computer 30 analyzes images from all the cameras to detect a falling or fallen package, or a rotation of any one or more of the packages and/or the pallet as explained above. The computer 30 stops the conveyors in response. Again, more often, pallet tipping occurs near a transition from one conveyor to another, but cameras could be positioned all along the conveyor.

### Weight Sensor Confirmation

FIG. 45 is a schematic plan view of a portion of the high speed wrapper conveyor system of FIG. 41, with optional equipment proximate the weigh conveyor 518. In this example, one or more cameras 524 are directed toward the volume above the weigh conveyor 518. Images from the cameras 524 are received by the computer 30. The computer 30 analyzes one or more of a series of images from the one or more cameras 524 to determine when the pallet 42 is completely on the weigh conveyor 518. When the computer 30 determines that the pallet 42 is completely on the weigh conveyor 518 (e.g. every one of the plurality of legs is on the weigh conveyor 518), the computer 30 causes the weigh conveyor 518 to stop and the computer 30 records the weight of the loaded pallet 42 from the weigh conveyor 518. In this environment, the power supply may be very noisy/dirty. Further, the gears driving the weigh conveyor 518 also cause vibration which causes noise on the weight reported by the weigh conveyor 518. By making sure that the pallet 42 is completely on the weigh conveyor 518 and then stopping the weigh conveyor 518 before recording the weight, a more accurate reading is obtained.

Alternatively, as shown in FIG. 45, a photoelectric sensor 526 may be used in place of the cameras 524 to determine when the pallet 42 is completely on the weigh conveyor 518. The photoelectric sensor 526 may be implemented via a PLC integration. The pallet legs break the beam of the photoelectric sensor 526. The computer 30 counts the number of pallet legs that have passed by the photoelectric sensor 526. When all of the pallet legs have passed by the photoelectric sensor 526, then the computer 30 waits a short predetermined period of time for the pallet 42 to be completely on the weigh conveyor 518. Again, then the computer 30 stops the weigh conveyor 518 and records the weight from the weigh conveyor 518.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified in the claims.

What is claimed is:

1. A method for identifying a SKU of a package using a computer system having at least one processor, wherein the computer system stores a plurality of pick lists, wherein each pick list indicates a quantity of each of a plurality of desired SKUs for an order, the method including:
a) receiving an image of a package in the computer system, wherein the image includes at least one face of the package;
b) the computer system determining a normal vector of each of the at least one face of the package in the image;
c) based upon step b) and based upon the image, the computer system determining a SKU associated with the package; and
d) the computer system comparing the SKU determined in step c) with at least one of the plurality of desired SKUs.

2. The method of claim 1 wherein step c) further includes correcting distortion of the image based upon the normal vector to produce a corrected image and wherein step c) further includes determining a SKU based upon the corrected image.

3. The method of claim 1 wherein the at least one face includes two faces and wherein step c) includes determining that the two faces are two faces of the package rather than two packages.

4. The method of claim 1 wherein step c) includes the computer system inferring the SKU associated with the package using at least one machine learning model, wherein the computer system includes at least one non-transitory computer-readable media storing the at least one machine learning model, wherein the at least one machine learning model is trained with a plurality of images of packages of beverage containers.

5. The method of claim 1 further including illuminating the package with at least one light while capturing the image of the package in step a), wherein based upon step d) the computer system generates a confirmation by changing the at least one light to green or an error notification by changing the at least one light to red.

6. A method for preventing an object from tipping on a conveyor including:
a) receiving at least one image of an object in a computer system, wherein the at least one image includes at least one face of the object; and
b) based upon the at least one image, the computer system determining an angle of the object relative to the conveyor or a change of the angle of the object relative to the conveyor; and
c) based upon step b) the computer system stopping the conveyor.

7. The method of claim 6 wherein the object is a pallet loaded with packages.

8. The method of claim 7 wherein step b) includes the computer system determining a normal vector of at least one face of the pallet or of at least one face of at least one of the packages.

9. The method of claim 8 wherein step b) includes the computer system determining an angle of the normal vector relative to a direction of travel of the conveyor and wherein step c) is performed by the computer system based upon the angle.

10. The method of claim 7 wherein the at least one image includes at least two images, wherein step b) includes determining the normal vector in each of the at least two images, and wherein step b) includes the computer system determining a rate of rotation based upon the normal vectors determined in each of the at least two images and comparing the rate of rotation to a threshold.

11. The method of claim 6 wherein the at least one image includes at least two images, wherein step b) includes determining a normal vector of at least one face of the object in each of the at least two images, and wherein step b) includes the computer system determining a rotation of the object based upon the normal vectors determined in each of the at least two images and comparing the rotation to a threshold.

12. The method of claim 6 wherein the at least one image includes at least two images, wherein step b) includes determining a normal vector of the at least one face of the object in each of the at least two images, and wherein step b) includes the computer system determining a rate of rotation of the objected based upon the normal vectors determined in each of the at least two images and comparing the rate of rotation to a threshold.

13. A conveyor system comprising:
a first conveyor leading to a second conveyor at a transition area;
at least one camera directed toward the transition area;
a computer system receiving at least one image from the at least one camera, the computer system configured to:
a) receive the at least one image of an object proximate the transition area, wherein the at least one image includes at least one face of the object;
b) based upon the at least one image, determine an angle of the object relative to the conveyor or a change of the angle of the object relative to the conveyor; and
c) based upon step b) the computer system stopping at least one of the first conveyor or the second conveyor.

14. The conveyor system of claim 13 wherein the object is a pallet loaded with packages.

15. The conveyor system of claim 14 wherein step b) includes the computer system determining a normal vector of at least one face of the pallet or of at least one face of at least one of the packages.

16. The conveyor system of claim 15 wherein step b) includes the computer system determining an angle of the normal vector relative to a direction of travel of the first conveyor and wherein step c) is performed by the computer system based upon the angle.

17. The conveyor system of claim 15 wherein the at least one image includes at least two images, wherein step b) includes determining a normal vector of at least one face of the object in each of the at least two images, and wherein step c) includes the computer system determining a rotation of the object based upon the normal vectors determined in each of the at least two images and comparing the rotation to a threshold.

18. The conveyor system of claim 13 wherein the at least one image includes at least two images, wherein step b) includes determining a normal vector of at least one face of the object in each of the at least two images, and wherein step c) includes the computer system determining a rotation of the object based upon the normal vectors determined in each of the at least two images and comparing the rotation to a threshold.

19. A validation system comprising:
a first camera tower having a plurality of first cameras vertically spaced from one another; and
a second camera tower having a plurality of second cameras vertically spaced from one another and directed toward the plurality of first cameras, a main imaging area defined between the first camera tower and the second camera tower, the second camera tower further including a front camera directed at an oblique angle relative to the plurality of second cameras, the front camera directed toward an initial imaging area spaced away from the main imaging area.

20. The validation system of claim 19 wherein the first camera tower is between approximately 76 inches and approximately 96 inches away from the second camera tower.

21. The validation system of claim 19 wherein the first camera tower is between approximately 83 inches and approximately 96 inches away from the second camera tower.

22. The validation system of claim 19 further including a half pallet having a length longer than a width wherein a distance between the first camera tower and the second camera tower exceeds the length by approximately 24 inches or less.

23. The validation system of claim 19 further including a rear tower having a rear camera, the rear tower spaced away from the first camera tower and the second camera tower, the rear camera directed toward the main imaging area.

24. The validation system of claim 23 wherein the rear tower is positioned adjacent the initial imaging area and the rear camera is configured to image a long side of a half pallet positioned between the first camera tower and the second camera tower.

25. The validation system of claim 24 wherein the rear tower further includes a user interface for receiving an indication of a pick list or pallet id corresponding to a pallet to be validated by the validation system.

26. The validation system of claim 24 further including a computer system including:
at least one processor; and
at least one non-transitory computer-readable media storing:
at least one machine learning model that has been trained with a plurality of images of packages; and
instructions that, when executed by the at least one processor, cause the computer system to perform the following operations:
a) receiving at least one image of a plurality of packages stacked on one another from each of the first cameras, the second cameras, the front camera, and the rear camera;
b) identifying a SKU associated with each of the plurality of packages based upon the images received in operation a) using the at least one machine learning model;
c) comparing the SKUs identified in step b) to a plurality of desired SKUs on a pick list; and
d) indicating an error or a confirmation based upon step c).

27. The validation system of claim 26 further including at least one light for illuminating the plurality of packages while capturing the at least one image), wherein operation d) includes the computer system changes the at least one light to green to indicate the confirmation or the computer system changes the at least one light to red to indicate the error.

28. An automated mobile robot (AMR) comprising:
a base portion;
a plurality of wheels supporting the base portion;
an upper platform for supporting a pallet thereon;
at least one weight sensor measuring a weight on the upper platform; and
at least one processor configured to receive a signal indicating the weight measured on the upper platform and to transmit the weight wirelessly via a wireless communication circuit.

29. The automated mobile robot of claim 28 further including an RFID reader configured to read a pallet id from an RFID tag of a pallet supported on the upper platform, the at least one processor configured to receive the pallet id from the RFID reader.

30. The automated mobile robot of claim 28 wherein the at least one processor is configured to cause the AMR to: retrieve at least one pallet from a pallet dispenser, receive a plurality of packages on the pallet, bring the plurality of packages to a validation station, and respond to a confirmation or error indication from the validation station.

31. The automated mobile robot of claim 30 wherein the at least one processor is configured to cause the AMR to continue to receive additional packages on the pallet based upon a confirmation from the validation station.

32. The automated mobile robot of claim 30 wherein the at least one processor is configured to cause the AMR to place the pallet and the plurality of packages on a specific spot on a floor near a loading docket based upon a command received from a remote computer.

33. The automated mobile robot of claim 32 further including at least one camera monitoring a position of the AMR and a position of the pallet and the plurality of packages and sending the position of the AMR and the position of the pallet and the plurality of packages to the remote computer.

34. The automated mobile robot of claim 28 wherein the at least one processor is configured to cause the AMR to: receive at least one package thereon, measure the weight of the at least one package using the at least one weight sensor, compare the measured weight to an expected weight of the at least one package, and bring the at least one package to a quality check station based upon a sufficient mismatch between the measured weight and the expected weight.

35. A validation system including the automated mobile robot of claim 28, the system further including:
at least one camera;
wherein the at least one processor on the AMR is configured to bring a pallet and at least one object supported thereon to the at least one camera and to present sequentially each of a plurality of sides of the at least one object to the at least one camera.

36. The validation system of claim 35 wherein the at least one processor of the AMR is configured to present each of the plurality of sides of the at least one object at at least two different angles.

37. A method for identifying a SKU of a package using a computer system having at least one processor, wherein the computer system stores a plurality of pick lists, wherein each pick list indicates a quantity of each of a plurality of desired SKUs for an order, the method including:
a) receiving in the computer system a plurality of images of a plurality of packages stacked on one another;
b) the computer system identifying a bottom edge of bottom packages of the plurality of packages in each of the plurality of images;
c) the computer system determining a slope of the bottom edge in each of the plurality of images;
d) based upon step c) and based upon at least one of the plurality of images, the computer system determining a SKU associated with each of the plurality of packages; and
e) the computer system comparing the SKUs determined in step d) with at least one of the plurality of desired SKUs.

38. The method of claim 37 wherein step d) further includes the computer system choosing the at least one of the plurality of images based upon the slopes of the bottom edges in the plurality of images and wherein the computer system determining the SKU associated with each of the plurality of packages using the at least one of the plurality of images chosen.
